(19) United States
(12) Patent Application Publication
(10) Pub. No.: US 2001/0020927 A1
(43) Pub. Date: Sep. 13, 2001

(54) Secondary cell using system

(76) Inventors: Kyoko Ikawa, Hitachi-shi (JP); Yasushi Muranaka, Hitachinaka-shi (JP); Yosimi Komatu, Hitachi-shi (JP); Tatsuo Horiba, Hitachi-shi (JP); Yoshiro Mikami, Hitachi-shi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/788,696

(22) Filed: Feb. 16, 2001

Related U.S. Application Data
(63) Continuation of application No. 09/051,212, filed on Aug. 24, 1998.
Application No. 09/051,212 is a 371 of international application No. PCT/JP95/02054, filed on Oct. 6, 1995.

(51) Int. Cl. G09G 3/36

(52) U.S. Cl. 345/87

(57) ABSTRACT

A system using a secondary cell having at least one of a heat source, motor, controlling circuit, driving circuit, LSI, IC and display element, each having a capacity of 0.5 to 50 kWh, and secondary cells, wherein at least one of the secondary cells includes a positive electrode and a negative electrode and has a discharge time of at least 15 minutes at a discharge of 580 W/l or more, and at least one of the positive electrode and the negative electrode containing a particle with cracks.

### CROSS REFERENCE TO RELATED APPLICATION

This is a continuation of U.S. application Ser. No. 09/051,212, filed Apr. 3, 1998, the subject matter of which is incorporated by reference herein.

### TECHNICAL FIELD

The present invention relates to a secondary cell system, and more particularly to a secondary cell system having excellent rapid charge and rapid discharge characteristics.

### BACKGROUND OF THE INVENTION

In recent years, a secondary cell has become one of the essential components for power sources of such devices as personal computers, portable telephones, electric vehicles, or electric power storage systems. Characteristics necessary for mobile communications (mobile computing), such as by portable computers, including pen computers, and mobile communications using information terminals, personal digital assistants, a personal intelligent communicator or a hand held communicator, are low power consumption, installation of high performance-long life batteries and miniaturization. However, the performance of the conventional secondary cell is still insufficient, and because the consumption of electric power of the back light of a liquid crystal display panel and the drawing control is large, the operating time of the cell is only 8 hours or less, even with a charging time of 8 hours. Thus, the actual fact is that the function of mobile computing still cannot be sufficiently exhibited.

In addition, electric vehicles which do not exhaust gas and produce noise are drawing more of people's interest as globe environmental problems increase. But, there are problems in electric vehicles, such as difficulty to achieve high speed driving, the need for a long charge time of 6 to 8 hours, a short range of driving, bad acceleration, etc. These problems are caused for the most part by insufficient performance of the secondary cell. Thus, a high performance of the secondary cell is the key to high reliability, high efficiency and ultra-miniaturization of the electric vehicle system for the 21st century.

A secondary cell having a large energy capacity and for which the operating time of equipment for a single charging of the cell can be extended is drawing attention in view of the demand for such equipment. The requirement for a large energy capacity by consumers is strong. For this reason, nickel-metal hydride secondary batteries and a lithium secondary batteries operating as a secondary cell have been under development in recent years. In the nickel-metal hydride batteries, negative electrodes, whose main component is a metallic alloy for hydrogen storage, are used. The nickel-metal hydride batteries also are interchangeable with nickel-cadmium batteries with respect to cell voltage, discharge characteristics, etc. and the cell capacity is expected to increase by 50 to 100%.

The lithium secondary batteries are high capacity batteries like the nickel-metal hydride batteries because their cell voltage is high, and they are light in weight. From the view point of consideration for the environment, such as a shortage of petroleum resources, ozone layer destruction by the emission of carbon dioxide gas, and the leveling of the electric power consumption, it is thought that the above batteries can be used as large-sized power sources, such as for an electric vehicle and an electric power storage power source of the dispersal type in the future.

Considering the ease of handling of the batteries, an improvement in the rapid charge characteristics that indicate how rapidly the batteries can be charged has been required. When it comes to equipment that needs a large current discharge, like electric vehicles, a rapid discharge properly is also important. If the large current discharge characteristic of a battery is insufficient, the application of the battery becomes very limited.

In lead batteries and nickel-cadmium batteries, the rapid charge and rapid discharge characteristics are satisfactory to some extent, but the characteristics of the nickel-metal hydride batteries and lithium secondary batteries are insufficient. In order to improve the rapid charge and discharge characteristics of the nickel-metal hydride batteries, several methods have been proposed. An electrode made of a hydrogen storage alloy of super fine particles having an average grain size of 5 microns or less has been used. (Japanese patent Laid-open print No. 60-119079). Pores of a diameter of 30 microns or more have been provided in a sheet-form metallic alloy for a hydrogen storage electrode containing a binding agent (Japanese patent Laid-open print No. 61-153947). The surface of the hydrogen storage alloy particles (mother particles) has been coated with particles of a pure metal of which the average particle diameter is 1/10-1/200 of the mother particles of a nickel base alloy or of a stainless steel (Japanese patent Laid-open print No. 64-6366). A hydrogen storage alloy consisting of disorderly arranged multiple-component materials constituted by a combination of polycrystalline materials, being amorphous, microcrystalline or long-range, that lack a structural order, have been used (Japanese patent publication No. 4-80512).

In lithium batteries, the surface of the collector body has been coated with nickel or titanium so as to improve the rapid charging and discharging characteristics (Japanese patent Laid-open print No. 5-159781). A secondary battery of the plate type that is able to fulfill all these requirements is not yet available; and so, a battery in which the secondary cell has an excellent capacity and a rapid charging property, and which is matched to the size requirement of the above system, is needed as a power source for portable computers and portable information terminals.

A high capacity secondary cell must be used for electric vehicles in order to extend the driving distance, but the voltage characteristics of the lithium secondary cell and nickel-hydrogen secondary cell greatly decline in the high output region of use. Increasing the recovery rate of regeneration energy during braking is essential for realization of high efficiency operation. For this purpose, secondary batteries of large capacity, and which have excellent rapid charge and rapid discharge properties, are necessary.

In general, the electrode used for these batteries is manufactured as follows.

After finely grinding particles of a material that participates in the cell reaction, the porous electrode plates are manufactured by forming a sheet with a binding agent for binding the particles or by binding the particles by sintering them. Making the average grain size smaller also increases the area of cell reaction in the porous substance layer that participates in the cell reaction. However, as particles of the substance relating to the cell are made finer, the tendency of the material to dislodge from the electrode becomes larger, so that the cell capacity declines. A coating of impurities is formed on the material surface that participates in the cell reaction during the process of fine grinding so that the coating becomes resistance to cell reaction, causing a lowering of the rapid charge and discharge characteristics It is thought that there might be an increase in the reaction area when pores are formed in the material surface that participates in the cell reaction, but there is no such effect even if fine pores are formed in the binding agent or between the particles. The provision of several pores in the electrode causes reduction of the filling density of the material that participates in the cell reaction rather than an increase in the reaction area, causing a lowering of the capacity as a practical matter. Because such forming of pores lowers the electric contact between grains, the rapid charge and discharge characteristics are deteriorated, instead. The formation of continuous cracks causes the same result.

In the method of arranging conductive particles around the substance relating to cell grains, the configuration of the arranged particles is of fibrous or film-form. As for the kinds of particles, carbon, metals or catalysts, etc. are acceptable. When a substance that has no cell reaction or has little action is added, the cell capacity may drop. When the crystal structure of the substance relating to the cell is given a non-ordering structure by use of a random multiple component substance which comprises materials of polycrystalline, amorphous and/or microcrystalline form, storing sites and active sites appear so that the surface area substantially increases.

The grain boundaries of the above mentioned disorderly material are disorderly and not clear. Thus, the stress caused by expansion-shrinkage at the time of charging and discharging is relaxed so that it is hard to generate cracks and voids and the electric contact between particles does not deteriorate. Accordingly, the storage capacity is large, and the cycle life is also long. As for the cell reaction during rapid charge and discharge, the charge-transfer reaction on the surface of the particles controls the cell reaction. Even if a lot of storing sites and active sites are formed three-dimensionally in the material, the speed of the cell reaction can not catch up with the speed of rapid charging and discharging, if the reaction area of the surface is small.

The method of coating the collector with a conductive material, such as nickel or titanium, is carried out to make the contact resistance of the collector and the substance relating to the cell small, and there are different methods for doing this. But, the resistance in the electrode, for example, the contact resistance between particles and the reaction resistance between particles and the electrolyte is much larger than the contact resistance between the collector and the substance relating to the cell reaction. A method for effectively improving the rapid charge and discharge characteristics of the batteries has not been discovered yet.

It is an object of the present invention to provide a secondary cell having improved rapid charge and discharge characteristics.

### SUMMARY OF THE INVENTION

The present invention relates to a secondary cell for use in a system that contains one or more loads with a capacity of 0.5 to 50 kWh. The unit cell of the secondary cell is able to discharge at least 580 W/l for 15 minutes or more. The load is a heat source, power source, controlling circuit, driving circuit, LSI, IC and display element, for example. At least one of the batteries of the secondary cell using system is able to make a charge of 90% or more of the cell capacity at 300 W/l or more of charge, and able to effect a discharge of 200 Wh/l or more.

The ratio of the maximum performance time of the 5 secondary cell to the charge time of the secondary cell is 10 or more, and preferably 40 or 200. The system using the secondary cell contains at least one of a liquid crystal display, multiple-layered wiring board, PCMCIA card (PC card), voice card, modem, portable telephone, facsimile and IC for the cell.

In a liquid crystal display system having a memory storage and which contains a liquid crystal panel, a panel driving peripheral circuit and a display interface circuit, the present invention relates to a secondary cell which is able to effect rapid charging within one hour, preferably within 30 minutes or less, and to effect maximum continuous operation for 10 hours or more, preferably 40 hours or more. The liquid crystal display system may or may not contain a beck light as a component. In case of a display operating in the reflection mode, the display is power saving because a back light is unnecessary. The liquid crystal display system can have the circuit integrated on the panel. In addition, the cell system can be used in the power-saving system mode that omits periodic read-out of the field memory storage and periodic writing to the pixels.

The low power consumption characteristics of a liquid crystal display system will exhibit further advances in the future. The consumption of power will become 1/50 of the present consumption of power in the future. In case the secondary cell system of the present invention is employed, the liquid crystal display system will be able to work continuously for 5 days at 8 hours per day. Further, the present invention relates to a secondary cell system which comprises a secondary cell having the capacity of 2 Wh or more per inch of the liquid crystal display panel and at least one of a cell charger, charge control equipment, a charge controlling circuit and a management system having a capacity of 2 W or more, preferably 8 to 36 W per inch of the liquid crystal display panel and a rapid charge performance of one hour or more per one inch of the liquid crystal display panel.

The secondary batteries used in accordance with the present invention have a rapid charge of at least 1 CmA, preferably at least 2 CmA, when they are used in assembled batteries. The charge control of the present invention is a constant-current charge, a constant-potential charge or a constant current constant-potential charge. The charge control may involve a −ΔV charge method, a method wherein charging is stopped in response to a temperature rise, a method wherein the charging is shutdown at a predetermined potential, or a method wherein charging is shutdown in a predetermined time. And, pulse charging is acceptable. By monitoring the voltages of the batteries, charging is carried out by bypassing current to avoid overcharge of the batteries. By taking out a signal from a microcomputer that is built in the batteries, the charge is controlled.

The system can have a management system that indicates the kinds of batteries, the charge voltage, the charge current, the alarm signal and the cell condition. The liquid crystal display system has secondary batteries, which are disposed in a space having a width of 0.85 to 1.2 per the width of the screen of the liquid crystal display panel and a length of 1.0 to 1.8 per the length of the screen of the liquid crystal display panel, and a thickness of 3 to 20 mm. The secondary cell system of the present invention can have a built-in microcomputer that controls-the charging or discharging or both. The liquid crystal display system has a secondary cell composed of a set of six or less batteries in parallel in two series or less, wherein lithium secondary batteries are used as the secondary batteries. The lithium secondary batteries may be lithium ion batteries. The nickel-hydrogen secondary batteries are used as secondary batteries composed of a set of four or less batteries in three to five series. The nickel-hydrogen secondary batteries may be batteries using a metallic alloy for hydrogen storage.

The secondary batteries that can be applied to the present invention are lithium secondary batteries or nickel—hydrogen secondary batteries. Nickel—cadmium batteries and lead batteries are improper for the present invention because their capacity is too small, even if their rapid charging characteristics is acceptable. The secondary cell system of the present invention includes at least one of a liquid crystal display, a multiple-layered wiring board, a PCMCIA card (PC card), a voice card, a modem and an IC for receiving power from the cell. In addition, a circuit for preventing an overcharge and an over-discharge of the secondary batteries, or a circuit for controlling charge-discharge, is integrated with the circuit in the system.

The liquid crystal display system of the present invention can be applied to such systems as a portable information terminal, a portable computer, a pencomputer, a portable telephone, a personal-handy phone or a system with the function of a video telephone.

In addition, the secondary cell system of the present invention can be applied to electric vehicles, elevators, electric cars and emergency power sources. In electric vehicles having secondary batteries, with the driving parts including a motor and an inverter, the secondary cell system is able to be rapidly charged within one hour, preferably 30 minutes or less, and can drive the vehicle for a distance of at least 250 km at a speed of 40 km/h with one charge. The weight of the system is 200 kg or less. The electric vehicle of the present invention uses secondary batteries which are chargeable within 30 minutes or less. The cell system of the present invention has the travel distance of 250 km or more at a speed of 40 km/h by one charge. The secondary cell system of which total weight is 200 kg or less that can secure the above travel distance is mounted on the vehicle. The minimum time necessary for acceleration from standstill to 400 m by the above electric vehicle is 18 seconds or less. In the electric vehicle using the secondary cell system and a fuel cell or solar cell with a control part that controls the operation of these devices with the motor driven by the secondary cell, the secondary cell is able to be rapidly charged within one hour or less, preferably 30 minutes or less, and it is possible to drive at least 300 km at a speed of 40 km/h by discharge of the secondary cell and/or generation of a fuel cell or solar cell. Moreover, the total weight of the secondary cell and the fuel cell or the solar cell is 250 kg or less. A hybrid power source combined with a gasoline engine also is acceptable.

The features of the secondary cell used for the system of the present invention are explained below.

The positive electrode or the negative electrode contains a particle material that participates in the charge and discharge reaction. The particles contain at least two phases. At least one of the multiple phases consists of electrodes having fine pores.

The particles are made of at least two multiple phases. At least one of the multiple phases has pores and cracks. At least another one of the multiple phases has fine pores formed by dissolution.

The particles have fine pores formed by dissolution or vaporization of at least one of the multiple phases and have cracks formed by formation of a charge reaction product or the discharge reaction product. At least two of the phases are materials that can participate in charge or discharge reaction and have a different charge capacity or discharge capacity from each other. Either the charge capacity or the discharge capacity does not become an issue.

When the value of the charge capacity or the discharge capacity of the two phases is different, stress fracturing will occur to form cracks. At least two of the phases are materials that exhibit a different expansion coefficient or different coefficient of contraction during the charge or the discharge reaction. The value of the expansion coefficients or the coefficients of contraction is not a problem. When the values of the expansion coefficient or the coefficient of contraction of the two phases are different, stress fracturing will occur to form cracks. The expansion coefficient or the coefficient of contraction is determined by the increase or decrease of the lattice constants obtained by X-ray diffraction measurement.

The cracks are formed in at least one region selected from the regions consisting of at least one of fine pores that participate in the charge or discharge reaction, their boundaries and combinations thereof. The cracks pin the phases that remain in a phase which does not participate in the charge-or discharge reaction or in the phase that remains undissolved or not vaporized so that the cracks do not spread anymore. Therefore, the cracks do not progress to form bores generated from the deep cracks, so that the electric contact between particles is not broken.

It is possible to increase the reaction area of the surface by forming many short cracks, because there are a lot of sources of cracks, such as at least two phases that participate in the charge and discharge reaction, as well as the existence of the fine pores, and their boundaries to which stresses are easily applied. The cracks of the particles can be formed by at least one method selected from the charge reaction, the discharge reaction of the cell, similar reactions, or reactions between the particles with at least one of an electrolyte, acid, alkali, oxidizing agent and reducing agent or the reactions of their combinations. Similar reactions are reactions between hydrogen in gaseous phase and a hydrogen storage metal at a certain temperature under a pressure where the metal absorbs and desorbs hydrogen in the case of a metallic alloy for hydrogen storage of the nickel-metal hydride secondary cell. Similarly, the reactions to absorb hydrogen in the alloy, which is accompanied by the occurrence of hydrogen gas in the liquid phase is used, for example, a thermodynamic reaction between lithium and the particles in case of a lithium secondary cell. An example of a reaction with the electrolyte is the corrosion reaction or oxidation reaction between the electrolyte and the alloy that are generally used for the nickel-metal hydride secondary batteries in case of a hydrogen storage metal alloy of the nickel-metal hydride secondary cell.

In the case of a lithium secondary cell, the reactions are a decomposition reaction of electrolytes in the surfaces of negative electrode or positive electrode or reactions between the impurity in the negative electrode or positive electrode and the electrolyte or reactions between active sites, for example, radicals and the electrolyte.

Fine pores are present in the particle surface that touches the electrolyte. The pores contribute to the cell reaction, and thus they must be present at least in the surface in contact with the electrolyte.

The surface of the particles of the material that participates in the charge and discharge reaction has pores in the electrode of the cell of the present invention. The composition of the pore surface is different from the composition of the particle surface. The particles are so-called primary particles. Unlike the pores formed between particles by making the particles gather, an active coating is formed in the surface of the pores made by dissolution, etc. by the elements, etc. that exist on the particle boundaries of the phases and other phases formed by dissolution, etc. or evaporation.

The particles are composed of several phases, at least one of which is dissolved or vaporized to form pores, and the surface of the pores contains transition metals or noble metals. The transition metals or noble metals exist in the coating of the oxides, hydroxides, carbonates, chelate complexes and solid solutions of different metals. In the case where the particles consist of alloys, the particles may be an alloy including at least two kinds of elements, the alloy having a first phase and at least one second phase precipitated in the first phase. At least one second phase has pores formed by evaporating or dissolution. At least one of the second phases is a material that shows the charge and discharge capacity different from that of the first phase. In addition, cracks may be formed in the particles.

When the principal component of the particles is carbon, the-carbon particles have at least one phase. The pores are formed in the surface of the carbon by dissolution or vaporization of at least one of the phases. The pores exist only in the face that can be in contact with the electrolyte. The pores do not necessarily exist in the interior of the particles that cannot be in contact with the electrolyte. When the particles are of carbon and an additive component, the phases are the additive component or compounds of carbon and the additive component.

At least one of the phases is a material that shows a charge and discharge capacity which is different from that of carbon. And, cracks are formed in the particles. When the particles are oxides or sulfides, the material is oxides or sulfides containing at least two kinds of elements. These compounds have a first phase and at least one kind of second phase precipitated in the first phase, at least one of the phases having pores formed by dissolution or vaporization of at least one of the phases.

At least one of the second phases is a material that shows a charge and discharge capacity different from that of the first phase. The cracks are formed in the particles. The secondary cell used for the present invention is able to discharge for at least 15 minutes at 580 W/l of output density per one cell. This cell is able to discharge at least at 200 Wh/l in 90% or more of the cell capacity at a charge of 300 W/l or more.

The secondary cell used for the present invention is explained in more detail below.

The positive electrode and/or the negative electrode of the present invention are manufactured by the following processes:

1) a process for manufacturing the negative electrode by agglomerating particles of a substance relating to the cell reaction; and

2) a process for generating pores in the second phase by dissolution or vaporization of the first phase with two or more kinds of phases that participate in the charge and discharge reaction, at least one of the second phases being dissolved with an acid, alkali, oxidizing agent or reducing agent or evaporating it to form the pores.

The manufacturing process may further include the following steps:

3) a process for agglomerating the particles of the substance relating to cell reaction and shaping the particles into a positive electrode; and

4) a process for forming cracks in the shaped electrode by forming charged products or discharged products through the charge reaction, discharge reaction or a similar reaction.

In a secondary cell in which the positive electrode and the negative electrode are arranged to be in contact with the electrolyte, the manufacturing method of the electrodes of the present invention has the following processes:

1) a process for distributing reaction products of a first phase, a second phase that can participate in the charge and discharge reaction and a third phase that forms pores by dissolution or evaporation;

2) a process for crushing the product wherein the second and third phases are dispersed in the first phase;

3) a process for causing the crushed particles to make cracks by forming charge reaction products, discharge reaction products or similar reaction products; and

4) a process for molding the particles into plate.

There are methods for combining the particles, such as a mechanical alloying method, a method of solid phase reaction, a method of gas phase reaction, a method of liquid phase reaction, and a gas atomizing method (a method of spraying around the temperature from which the second phase separates).

As another method, the following one is proposed.

1) A first phase component, a second phase component that can participate in the charge and discharge reaction and a third phase component which is able to form pores by dissolution or evaporation of the component are mixed.

2) The component of the first phase is melted, cooled and crushed.

3) The third phase of the crushed particles is dissolved with an acid, alkali, oxidizing agent or reducing agent to form pores in the surface of the particles.

4) The particles with the pores can be molded into a plate.

As mentioned above, the pores are formed by bringing the third phase into contact with a reaction gas to effect selective evaporation of the third phase. The second or third phase can be formed by adding the second and third phases to the molten metal of the component of the first phase. The third phase is prepared from alloys, intermetallic compounds or single components that are able to be dissolved with acids, alkali, oxidizing agents or reducing agents, and then the alloys, etc. are dissolved with a dissolving agent to form pores, after which the product is formed into the shape of electrode (such as a plate).

It is possible to dissolve the third phase after molding the particles into an electrode configuration to form the pores. The present invention can be applied to the secondary cell that is composed of a negative electrode, positive electrode and an electrolyte distributed in the electrodes. If necessary, a separator is disposed between the positive electrode and the negative electrode. The present invention is desirably applied to closed type secondary batteries, such as nickel-metal hydride batteries, lithium batteries, etc.

The alloys used in accordance with the present invention are comprehended to cover so-called intermetallic compounds. For example, the secondary batteries can be batteries with a casing accommodating a positive electrode, a negative electrode of hydrogen storage alloy electrolyte and an electrolyte. The negative electrode made of a hydrogen storage alloy is formed by agglomerating the hydrogen storage alloy particles. A separator can be disposed between the positive electrode and the negative electrode. By applying the negative electrode made of a hydrogen storage alloy to the present invention, the catalytic activity of a hydrogen occlusion reaction can be obtained. By the catalytic activity of the active radicals (thought to be as active elements, etc. with a hole or unpaired electrons) that remain in the pores, the rapid charge-discharge characteristics can improved so as to extend the life of the cell.

The present invention can be applied to a secondary cell filled with a non-water electrolyte wherein a positive electrode and negative electrode are accommodated in a casing, which carries out charge-discharge operations by releasing and inserting alkali metal ions (for example, lithium ions) in the positive electrode and the negative electrode. In the case of carbon or a conductive polymer negative electrode, lithium ions are inserted from the edge part of a six membered ring to effect an intercalation reaction. Because there are a lot of edge parts of a six member ring, so-called end parts existing in the pores, the reaction can easily take place. As a result, rapid charge-discharge characteristics can be improved to realize a large energy capacity. Because the active material of the positive electrode is the anions in the electrolyte in the case of the positive electrode of conductive polymer, the electrolyte absorption rate by the pores can be increased, and the charge and discharge reaction can smoothly progress. In the case of the positive electrodes of metallic oxides or sulfides, metallic ions are substituted with transition metals in the positive electrode to form defects, whereby the lithium ions can be inserted into the defects. That is, the increase of the defects can increase the reaction sites of lithium to increase the energy capacity of the cell.

The configurations of the substance relating to cell reaction and pores can take any form, such as a ball, ellipse-form, cone-form, fibrous-form, doughnut-form, basket-form, cube, rectangular parallelepiped, or random shape. For example, the present invention can be applied to the following cell electrodes. If the performance is improved by forming the pores, the present invention also can be applied to other cell electrodes. A metallic alloy for hydrogen storage can be used which is made of the following components as a material that participates in the charge and discharge reaction of the negative electrode of the nickel-hydrogen cell. The following alloys, etc. are used which are composed of a first phase, a second phase that can participate in charge-discharge reaction and a third phase. The following alloys can be dissolved or evaporated to form the pores.

Alloys composed of nickel and at least one of magnesium, lanthanum, cerium, neodymium, praseodymium, titanium, zirconium, hafnium, niobium, palladium, yttrium, scandium and calcium

Alloys containing at least one of the following elements besides the above components.

Aluminum, cobalt, chromium, vanadium, manganese,

tin, barium, molybdenum, tungsten, carbon, lead,

iron, potassium, sodium, lithium and boron

For example, the following alloys are exemplified.

(La—Ce—Nd—Pr)-(Ni—Mn—Al—Co)

(La—Ce—Nd—Pr)-(Ni—Mn—Al—Co—B),

(La—Ce—Nd—Pr)-(Ni—Mn—Al—Co—W),

(La—Ce—Nd—Pr)-(Ni—Mn—Al—Co—Mo)

The range of ( )/( )=1/4.5-5.5, when converted in the atomic ratio. Among the alloys, the second phase that participates in the charge-discharge reaction is the following:

La_{0.5-2.5}Co, La_{0.5-2.5}Ni, La_{0.5-2.5}Mn, Ce_{0.5-2.5}Co_{0.5-2.5}Al, Ce_{0.5-2.5}Ni

At least one of V, Fe, Ti, Nb and Ca can be alloyed to the above alloys to compose the following alloys wherein the second phase containing the following components may be precipitated.

Ti_{0.5-2.5}Ni, Nb_{0.5-2.5}Ni, Ca_{0.5-2.5}Ni, Ti_{0.5-2.5}Fe, Ti_{0.5-2.5}V

Further, (Zr)-(Ni—V—Mn) alloys are acceptable. At least one of Co, Fe, Cr, Sn, Sn, B, Mo, W and C can be added to this (Ni-V-Mn) side further, and the range of ( )/( )=1/1.5-2.5, when converted in atomic ratio. At least one of Ti, Hf. Y and Nb can be added to the (Zr) side further. The combinations are, for example, Co and Mo, Co and B, Cr and Mo or Co and W, etc. The second phases that participate in the charge and discharge reaction are the following:

Zr_{0.5 to 2.5}CO, Ti_{0.5 to 2.5}V, Zr_{0.5 to 2.5}Ni, Zr_{0.5 to 2.5}Mn, Zr_{0.5 to 2.5}V, Ti_{0.5 to 2.5}Ni, Nb_{0.5 to 2.5}Ni, etc.

Ca, La, Ce, etc. can be added to the above alloys to obtain the second phases of the following.

La_{0.2 to 2.5}Ni, Ce_{0.2 to 2.5}Ni, Ca_{0.2 to 2.5}Ni, La_{0.2 to 2.5}Fe, Ce_{0.2 to 2.5}Co, Ca_{0.2 to 2.5}V, etc.

(Mg)-(Ni—Al—Mn) or (Mg)-(Ni—V—Mn), wherein at least one of Co, Fe, Cr, Sn, B, Mo, W and C is added to the (Ni—V—Mn) or (Ni—Al—Mn) side further. The range of ( )/( )=2/0.5-1.5, when converted in the atomic ratio. At least one of Zr, Ti, Hf. Y and Nb is added further to the (Mg) side. The second phases that participate in the charge and discharge reaction are:

Mg_{0.5 to 2.5}Co, Mg_{0.5 to 2.5}Ni, Mg_{0.5 to 2.5}Mn, Ti_{0.5 to 2.5}Co, Ti_{0.5 to 2.5}Fe, Ti_{0.5 to 2.5}V, Ti_{0.5 to 2.5}Ni, Ti_{0.5 to 2.5}Mn, Zr_{0.5 to 2.5}Ni or Hf_{0.5 to 2.5}Ni

Further, Ca, La, Ce, etc. are added to the above alloys to precipitate the following second phases:

La_{0.2 to 2.5}Ni, Ce_{0.2 to 2.5}Ni, Ca_{0.2 to 2.5}Ni, La_{0.2 to 2.5}Fe, Ce_{0.2 to 2.5}Co, Ca_{0.2 to 2.5}V, etc.

(Ti)—(Ni—Al—Mn) or (Ti)—(Ni—V—Mn), wherein at least one of Co, Fe, Cr. Sn, B. Mo, W and C is added to the (Ni—V—Mn) and (Mi—Al—Mn) side further in the range of ( )/( )=1/0.5-2.5, when converted in the atomic ratio. At least one of Zr, Mg, Hf, Y and Nb is added to the Ti side further. The second phases that participate in the charge and discharge reaction may be composed of the following.

Mg_{0.5 to 2.5}Co, Mg_{0.5 to 2.5}Ni, Mg_{0.5 to 2.5}Mn, Ti_{0.5 to 2.5}Co, Ti_{0.5 to 2.5}Fe, Ti_{0.5 to 2.5}V, Ti_{0.5 to 2.5}Ni, Ti_{0.5 to 2.5}Mn, Zr_{0.5 to 2.5}Ni, Hf_{0.5 to 2.5}Ni, etc.

Ca, La Ce, etc. are added to the above alloys to precipitate the following alloys.

### La_{0.2 to 2.5}Ni, Ce_{0.2 to 2.5}Ni, Ca_{0.2 to 2.5}Ni, La_{0.2 to 2.5}Fe, Ce_{0.2 to 2.5}Co, Ca_{0.2 to 2.5}V, etc.

For example, the phases of the following component can be used as a dissolution phase of the metallic alloy for hydrogen storage. In addition to V and Ti, the phase can contain any of B, C, Cr, W, Mo, Sn, Mg, K, Li or Na. In addition to Al and Mn, the phase can contain any one of B, W or Mo. Such phases as Ni—Ti, Zr—Ni, Zr—Mn, B—Al—Co, B—Ni—Mn, etc. are exemplified.

As materials that contribute to the charge and discharge reaction of the positive electrode of the lithium batteries, the compounds (alloys, etc.) of the following components are used. The following compounds, etc. containing the dissolution phase and the second phase that participates in charging and discharging can be used. Compounds (alloys) consisting of oxygen and at least one of lead, manganese, vanadium, iron, nickel, cobalt, copper, chromium, aluminum, molybdenum, boron, tungsten, titanium, niobium, tantalum, strontium, bismuth and magnesium are used. The compounds can be composite oxides. Compounds of sulfur and at least one of titanium, molybdenum, iron, tantalum, strontium, lead, niobium, boron, magnesium, aluminum, tungsten, copper, nickel, vanadium, bismuth and manganese are used. The compounds can be sulfides. The compounds can be complex compounds of sulfur and oxide containing lithium.

Conductive polymers (for example, polyaniline, polyparaphenylene, polyacene and polypyrrole) can be used. Compounds of the conductive polymers and at least one of the following elements can be used.

Carbon or compounds of carbon and at least one of iron, silicon, sulfur, copper, lead, nickel, vanadium, silver, boron, molybdenum, tungsten, aluminum and magnesium are used.

As a material that contributes to the charge and discharge reaction of the positive electrode of the lithium cell, the materials containing at least one of the following materials can be used. LiCoOₓ, LiMnOₓ, LiNiOₓ, LiFeOₓ, LiNi_{0.5}Co_{0.5}Oₓ, LiCo_{0.5}Mn_{0.5}Oₓ, LiNi_{0.5}Mn_{0.5}Oₓ, LiNi_{0.5}Fe_{0.5}Oₓ, LiFe_{0.5}Co_{0.5}Oₓ, LiFe_{0.5}Mn_{0.5}Oₓ, LiMn₂Oₓ, TiSₓ, MoSₓ, LiV₃O₂ₓ, or CUV₂O₃ₓ, LiAl_{0.5}Co_{0.5}Oₓ, LiAl_{0.5}Mn_{0.5}Oₓ, LiMg_{0.5}Mn_{0.5}Oₓ, LiAl_{0.5}Fe_{0.5}Oₓ, LiFe_{0.5}Mg_{0.5}Oₓ, or LiNi_{0.5}Al_{0.5}Oₓ. The sum of the transition metal components should be 0.8-1.3, but it is not necessarily 0.5. The range of X is 1.5-2.5.

As materials that contribute to the charge and discharge reaction of the negative electrode of the lithium cell, the materials containing at least one of the following compounds (alloys, etc.) can be used. Carbon (carbon black, furnace black, pitch like carbon, mesophase carbon, PAN series carbon, glassy carbon, graphite, amorphous carbon, fullerene and mixtures thereof. There are carbon compounds of the following elements such as iron, silicon, sulfur, copper, lead, nickel, vanadium, silver, boron, molybdenum, tungsten, aluminum and magnesium.

Conductive polymers (for example, polyaniline, polyacene and polypyrrole) can be used. There are compounds of the conductive polymers and the following elements such as iron, silicon, sulfur, copper, lead, nickel, vanadium, silver, boron, molybdenum, tungsten, aluminum, magnesium and carbon.

Alloys comprising at least one of manganese, nickel, copper, calcium, magnesium, germanium, silicon, tin, lead and silver. For example, Si—Ni, Ge—Si, Mg—Si, Si—Ni—Ge, Si—Ni—Mg, Si—Ni—Mn, Si—Ni—Cu, etc. can be used.

When manufacturing the materials consisting of alloys that contribute to the charge and discharge reaction, the components are melted and cast, and then the ingots are subjected to aging treatment or cooling at a controlled speed to form the second phase that dissolves in acids or alkalis, etc. and to form cracks. As alloying components for dispersing the deposition phases, additional elements can be contained to adjust the size of the precipitates. Desirable additional elements have the action to induce deposition of the alloying components. For example, the materials are formed so that dissolution phases disperse in the manufactured alloy (so-called primary particles in the case of particles). The alloy materials can be manufactured by a mechanical alloying method and a mechanical grinding method. The degree of alloying is controlled by optimizing the rotational frequency and time in the mechanical alloying method and the mechanical grinding method so that the phase that is dissolved in alkali and the second phase that participates in charge and discharge reaction are segregated by not making homogeneous the materials to manufacture desired negative electrodes (or particles for constituting the negative electrode).

When manufacturing the materials consisting of carbon and the conductive polymers that contribute to the charge and discharge reaction, the components for the dissolvable phase as raw materials are mixed and melted to disperse the dissolution phases and the second phase that participates in the charge and discharge in carbon, etc. In case the materials that contribute to the charge and discharge reaction are oxides, composite oxides, sulfide or composite sulfides, this method can be adapted, too.

Dissolution phases can be dispersed by mixing and heat-treating carbon, conductive polymer and components of the dissolving phase. A heat treatment temperature of 300° C. to 3500° C. is desirable. In case the materials are used for the positive electrode of the lithium cell, a preferable temperature is 300° C. to hundreds ° C. In case the materials are used as a negative electrode, the conductivity polymers are carbonized at 1000° C. to 3500° C. The material that participates in the charge and discharge reaction (so-called active substance) is obtained by heat-treatment after dissolving with an acid to form the pores. The materials can be evaporated by contact with the reaction gas instead of dissolution.

The present invention is hard to apply to a case where the composition in the material (so-called primary particles in case of particle-form) that contributes to the charge and discharge reaction becomes homogeneous as a whole by heat treatment (for example, uniformed processing, etc.). It is desirable that deposition phases that are easier to dissolve in an acid, alkali, etc. than the mother phase (the first phase) and the second phase that participates in the charge and discharge disperse in the first phase. The dissolution phase and the second phase that participates in the charge and discharge can be formed by deposition of the alloy, as mentioned above. For example, the particles can be mixed into the mother phase (the first phase) that consists of carbon and the conductive polymer as a dissolution phase and the second phase that participates in the charge and discharge in the case of carbon and conductive polymers.

The porous electrode of the present invention can be made by either of the following steps.

bonding with a binding agent

Mechanical pressurizing powder

Sintering

Chemical Agglutination

The electrode especially suitable for the present invention is an electrode of which the material contributing to the charge and discharge reaction is an electrode of a so-called intercalation type. In an electrode of the dissolution-deposition type, wherein the material participating in the charge and discharge reaction in the electrode dissolves from the surface of the electrode due to the charge and discharge reaction, the effect of the pores cannot be expected sufficiently, when repeated charging and discharging occurs.

The crack formation method that is especially suitable for the present invention is a method of pre-charging or pre-discharging after assembling the cell. As a result, charge products or discharge products are formed so that cracks are formed.

Materials such as acids, alkalis, oxidizing agents or reducing agents are used for making pores and cracks. Any materials which are not in conflict with the purposes of the present invention may be used, such as the following ones.

Acids: Nitric acid, hydrofluoric acid, hydrochloric acid and sulfuric acid

Alkalis: Potassium hydroxide and sodium hydroxide

Oxidizing agents: Sodium hypochlorite, potassium hypochlorite and hydrogen peroxide water

Reducing agents: formalin, hydrogenated boric acid sodium and phosphorous acid potassium, Sodium hypophosphite

As gases for evaporating the reacted material and forming pores in the electrode, reactive gases such as halogen and oxygen are used. The phase to be evaporated is brought into contact with halogen gas, such as F2, Cl₂ and Br₂ or O₂, to selectively evaporate the phase, thereby to form pores by means of a volume change. The present invention also can be applied to the electrode as it is.

The present invention relates to a power source system with an operation control unit for the power source in a power source system using a secondary cell in which the positive electrode and the negative electrode are arranged through the electrolyte, wherein a positive electrode or a negative electrode contains a particle material that participates in the charge and discharge reaction, the particles comprising at least two phases, at least one of which has pores and cracks, and wherein the output of the secondary cell is more than 580 W/l, and the cell can discharge for 15 minutes or more. The system is composed of a secondary cell and at least one of a fuel cell, solar cell, air cell and sodium-sulfur cell, wherein the secondary cell is used at the time of discharge at a high output. The rapid charge-discharge characteristics of the secondary cell that is applied to the system of the present invention exhibits 90% or more of the capacity for a charge of more than 300 W/l, and a discharge of 200 Wh/l or more is possible due to the effects of the pores or the cracks. The rapid discharge property is 15 minutes or more at 580 W/l, which is not found in the conventional cell.

When this cell is used for a secondary cell system having at least one of a heat source, power source, controlling circuit, driving circuit, LSI, IC and display element, each having a capacity of from 0.5 Wh to 50 kWh, The longest time that the system operates for charging is 10 times or more of the conventional system, and more preferably 40-200 times. When only batteries that cannot discharge 200 Wh/I or more in 90% or more of the capacity of 300 W/l or more are used, there is a case that the system maximum performance time for the charging time is smaller than 10 times. The operability of an electric vehicle, and systems having the function of a liquid crystal display system, a portable information terminal using the liquid crystal display system, a portable computer, a pencomputer or a portable telephone according to the present invention is remarkably improved. In a system with the function of a liquid crystal display system, a portable information terminal using a liquid crystal display system, a portable computer, a pencomputer, a portable television or a portable telephone, which use the secondary cell of the present invention, the charging time of the secondary cell can be shortened to one hour or less. Because a continuous duty for a long time, which has been difficult in the conventional system, becomes possible, the range of use widens to the destination of business trips, the outdoors or vehicle use.

The secondary cell used for the present invention has the characteristics of rapid charging in one hour or -less, preferably 30 minutes or less, and a long continuous duty of 40 hours or more. 40 Hours of operation provides for continuous operation for 5 days at 8 hours per day, which fulfills the requirement of normal businessmen.

In accordance with the present invention, the advantages of the present invention are evaluated based on the consumption of electric power of the liquid crystal display at 0.05 W per one inch of the display. It is necessary for the capacity of the cell to be 2 Wh or more per 1 inch. In case the cell capacity is smaller than 2 Wh, the longest continuous duty of 40 hours or more is difficult to attain. The charging of the secondary cell of the present invention is completed within one hour or less by charging at 2 W or more per one inch. In case the charge is smaller than 2 W, one hour or more charging time is necessary, and the secondary cell of the present invention is not necessary anymore.

Since the present invention provides a secondary cell of very small construction arranged in the reverse face of the liquid crystal display according to the present invention, the portability of the system is excellent. In order to realize 40 hours or more of continuous duty, it is necessary to dispose the secondary cell in a space having a width of 0.85 to 1.2 per the width of the screen of the liquid crystal display panel, a length of 1.0 to 1.8 per the screen of the liquid crystal display panel, and a thickness of from 3 mm to 20 mm. In case the secondary cell is larger than this, the cell can not be accommodated in the reverse face of the panel with the liquid crystal display and the circuit or the total thickness of the system becomes thicker so that the portability deteriorates.

The system of the present invention is designed on a premise that it supplies a voltage of around 5 V and has a size of 5 inches or less. The system has a potential boosting circuit and a step-down circuit. Therefore, when lithium secondary batteries are used, they are assembled into a set of batteries of 2 series or less and 6 batteries or less in parallel. The voltage of the cell at this time is 3.6 V to 7.2 V, and 5 V is obtained by using the voltage boosting circuit and the step-down circuit. When the number of batteries is more than 6 in parallel, the dispersion of the capacity of the individual cell shortens the cell life due to capacity distribution of the batteries.

In case nickel—hydrogen secondary batteries are used, a set of 6 or less in parallel and in 3 to 5 in series is assembled. As a result, a cell voltage of 3.6 to 6.0 V is obtained, and 5 V is obtained by using the voltage boosting circuit and the step-down circuit. In case the number of batteries is larger than 6 in parallel, the dispersion of the capacity of the individual batteries causes a distribution to shorten the cell life of the batteries.

In case the secondary cell of the present invention is used, the acceleration is excellent without shortening the running distance of the electric vehicle. In addition, since the charging time can be as short as one hour or less, the system can be charged even during driving. The electric vehicle of the present invention can be charged by a rapid charge of one hour or less, and the running distance at a driving speed of 40 km/h by one charge is 250 km or more and the cell weight is 200 kg or less.

If a nickel—cadmium cell and a lead cell are used, a rapid charge of less than one hour is possible, but it is impossible to achieve a cell weight of 200 kg in case these batteries are used and to make the driving distance at a driving speed of 40 km/h to be 250 km in one charge. The effect of the present invention was evaluated for an electric vehicle having a vehicle weight of 1000 kg or more. Therefore, the running distance of 250 km or more was not achieved by simply lightening the body weight. And, the cell weight is 200 KG or less. The running distance of 250 km or more was not achieved by increasing the cell weight. An electric vehicle that satisfies these values is enabled by using the secondary cell of the present invention.

In an electric vehicle using a secondary cell system with a control part that controls the output operation of these batteries, and the motor is driven by the secondary cell and a fuel cell or a solar cell as a power source, the rapid charge of the secondary cell is possible within one hour or less, preferably 30 minutes or less. The running distance of the electric vehicle having a driving speed is 40 km/h is 300 km or more in one discharge from the secondary cell and one generation by the fuel cell and/or the solar cell. The sum of the weight of the secondary cell and the fuel cell and/or the solar cell is 250 kg or less.

A hybrid power source consisting of a combination of the above batteries or cells for an engine can be used. The action of the secondary cell used for the present invention will be explained. Several phases that participate in the charge and discharge reaction in the secondary cell of the present invention may exist wherein their discharge capacity or their charge capacity is different, or their expansion coefficient or their coefficient of contraction at the time of charge and discharge is different. Further, pores formed by dissolution and evaporation may exist. The stress fracturing progresses in these phases by the expansion and shrinkage of the crystals at the time of the charge and discharge to generate the cracks. The formation of the cracks brings about an increase in the reaction area so as to greatly improve the rapid charge-discharge characteristics. The electrode has many crack initiation sources. One of them is in the phase that participates in the charge and discharge. Another is the cracks that occur along grain boundaries. Another is the cracks that occur in the pores. The phase that participates in the charge and discharge consists of several phases having a respectively different discharge capacity or charge capacity, or in which the expansion coefficient or coefficient of contraction at the time of charging and discharging is different, respectively, the respective phases are formed by a highly ordered material of high crystallinity. Clear grain boundaries exist between the phases. A large stress accumulates due to expansion and shrinkage at the time of charging and discharging between the phases of high crystallinity. Therefore, the formation of the cracks is easy. But these cracks do not grow to deep cracks or cavities. That is, the dissolution phase that could not dissolve and exist in the particle cores and the deposition phase that does not participate in the charge and discharge become pinning points to prevent the progression of the cracks.

The reaction area is increased by 2-10 times by the formation of minute cracks, and the charge-transfer reaction in the surface can smoothly progress. Because the charge-transfer reaction is the controlling step of a rapid charge and a rapid discharge, the rapid charge and the rapid discharge property can be remarkably improved. There are pores formed by dissolving the material with acids, alkalis, etc. (primary particle in the case of particles) that contributes to the charge and discharge reaction. The above process has an effect to increase the packing density of the material that contributes to the charge and discharge reaction in the electrode. The pores existing in the electrode manufactured by the compression molding of the particles are formed between particles or the attachment (for example, bearing object, etc.), so that the primary particle surface increases the specific surface area. As a result, the capacity of the batteries can be further improved.

Firstly, particles having pores are different from the cases in which a metal powder and a catalyst powder are added, but the specific surface area of the material that participates in the charge and discharge reaction increases the area of the reaction sites. Therefore, the rapid charging and the rapid discharging reaction smoothly progress. The particles having pores can participate in the reaction sufficiently. Therefore, as compared with an electrode having a surface which is processed at high temperatures, etc. after manufacture of the electrode, electric current concentration, etc. can be avoided in the electrode of the present invention so that the life of the electrode can be prolonged.

Because a larger amount of electrolyte is held in the pores than that of conventional electrodes, the charge and discharge reaction can smoothly proceed. The pores are formed by dissolving material in the dissolution phase by using reagents with high reactivity, such as acids, alkalis, oxidizing agents or reducing agents. Unlike pores composed of voids between particles, an inactive film (for example, an insulating film) like that usually exhibiting a firm oxidation coat is hard to form, and so a higher reactivity can be expected in the present invention. The coatings (for example, conductive oxide films) which are formed have a high activity and are not firm like the ordinary oxide film formed in the circumferential surface portion of the pores. The pore surfaces formed by dissolution of the phase become a non-continuous, random arrangement of atoms to form defects and voids, so that the state which is electronically charged to positive or negative can be formed. This may lead to an increase in the activity.

The kinds of elements that exist in the particle boundaries between the dissolution phase and another phase or the elements that exist in the dissolution phase, the dissolution phase and other phases brings about a large difference in the dissolution speed within a short time, and the composition of the pore surface changes into an active layer that is different from the composition before processing. Therefore, the activity in the pore surface is high. The defects are not mere pores, but they have catalyst layers (a layer that contributes to promotion of the reaction) to which minute etching is applied to form holes or positive holes of electrons and unstable layers (for example, charged layers). Therefore, it is not only due to capillary action, but the electrolyte is held in the pores by adsorption with electrons so that the reactants are catalytically activated to increase the rate of reaction.

Thus, the pores are clearly different from the pores that are formed between the particle boundaries of porous electrodes in their reactivity. Because the pores in the present invention are formed by dissolving the dissolution phase (the second phase and deposition phase) using reagents such as acids, alkalis, oxidizing agents and reducing agents, the pores are formed in the surfaces with which the reagents are in contact. For example, the pores exist only in the faces that can be in contact with the electrolyte to form the active reaction sites. Therefore, the components in the undissolved dissolution phase (the second phase and deposition phase) that exist in the inner parts of the particles are left in the cores, and their existence can be easily confirmed by analysis. Since this portion is essentially dissolved, it does not participate in the charge and discharge reaction, and thus its action and capacity are small. Therefore, it is important to optimize the dissolution conditions with reagents so as to decrease the residue as little as possible.

It is desirable that in order to certainly dissolve it, heat is applied from the outside, such as with hot acids or hot alkalis, to dissolve it certainly. In case the electrolytes are acids or alkalis, the undissolved dissolution phase (the second phase and deposition phase) in the dissolution operation is dissolved again with the electrolyte, when coming in contact with the electrolyte in the cell. Therefore, the components in the dissolution phase (the second phase and deposition phase) can elute into the electrolyte and can confirm their existence by analyzing the electrolyte.

In case the dissolution is dissolved in the electrolyte, the pores in the particle surfaces of the material that participates in the charge and discharge reaction are damaged by the cell operation, and by being in contact with the electrolyte of that place, new pores will be formed so that good a charging and discharging reaction can be maintained. It is not necessary to cause the eluted components to precipitate in another place positively. The effect of the present invention can be obtained by dissolving the material to form the pores. The components and the reaction products of the electrolyte sometimes remain in the pores.

The new surfaces may be formed by destruction (split, division, etc.) of the material that participates in the charge and discharge reaction in the electrode at the time of charging and discharging and are formed in contact with the electrolyte, and the dissolution phase faces the new surfaces that react with the electrolyte to form new pores.

### BRIEF DESCRIPTION OF DRAWINGS

FIGS. 1(a) to 1(d) show the analytical result of the segregation phase of example 1.

FIGS. 2(a) to 2(d) show the analytical result after dissolution of the segregation phase of example 1.

FIG. 3 is a perspective view in cross-section of the construction of the sealed type cell.

FIGS. 4(a) to 4(d) show the analytical result of the alloy of comparison example 1.

FIGS. 5(a) to 5(d) show the analytical result after the dissolution of the alloy of comparison example 1.

FIGS. 6(a) to 6(e) show the analytical result of the segregation phase of example 2.

FIG. 7 shows the crack formation in example 2.

FIG. 8 is a graph which illustrates a relationship between the ratio and the capacity ratio of the mean diameter at the pore site with respect to the average grain size of alloys of example 7 and comparison examples 7 and 8.

FIG. 9 is a graph which illustrates a relationship between the rate and the capacity ratio with respect to the grain surface area of the pore area of example 8 and comparison examples 9 and 10.

FIG. 10 is a graph which illustrates a relationship between the rate and the capacity ratio with respect to the grain volume of the pore part volume of example 8 and comparison examples 9 and 10.

FIG. 11 is a diagram which shows an example of a guidance system using the voice card of example 19 and comparison example 13.

FIG. 12 is a perspective view which shows the construction of a server and a voice card of example 19 and comparison example 13.

FIGS. 13(a) to 13(b) are diagrams which show the construction of the PC card of example 19 and comparison example 13.

FIG. 14 is a perspective view which shows the construction of the card of example 19 and comparison example 13.

FIG. 15 is a block diagram which shows the construction of the TFT circuit substrate of the liquid crystal display system of example 15 and comparison example 14.

FIG. 16 is a block diagram which shows the liquid crystal display system of examples 21-24.

FIG. 17 is a diagram which shows the volume of the set cell of examples 21-24.

FIG. 18 is a block diagram which illustrates an example of the power management function of the note personal computer of example 25.

FIG. 19 is a block diagram which illustrates an example of the hybrid electric power unit of example 27.

FIG. 20 is a circuit diagram which illustrates an example of the hybrid power source of example 27.

### BEST MODE FOR CARRYING OUT THE INVENTION

### EXAMPLE 1

As a negative electrode, the Ti_{0.2 to 2.5}Zr_{0.8}Ni_{1.1}Mn_{0.6}V_{0.2}B_{0.03} alloy (metallic alloy for hydrogen storage) was used.

The alloy components were melted at a temperature range between 1100 and 1500° C. and cooled at a cooling speed of 0.01 to 0.5° C/min., and then annealed for about 2 h at 300 to 900° C. The obtained alloy was crushed to form particles of an average particle size of 50 microns.

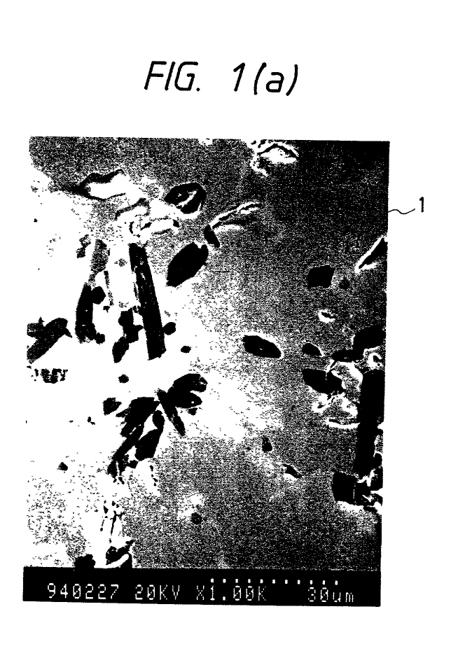

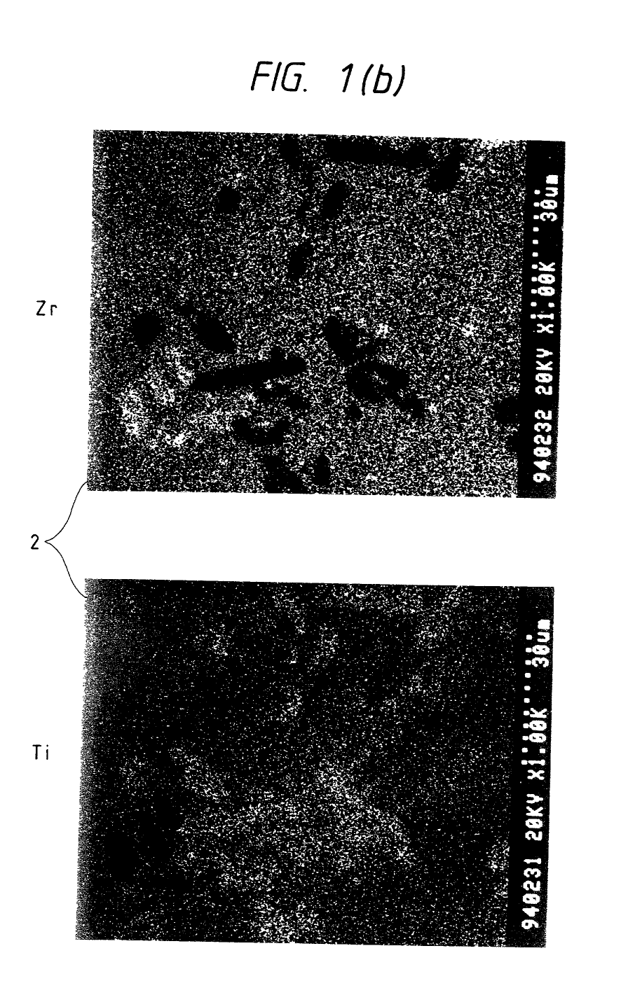

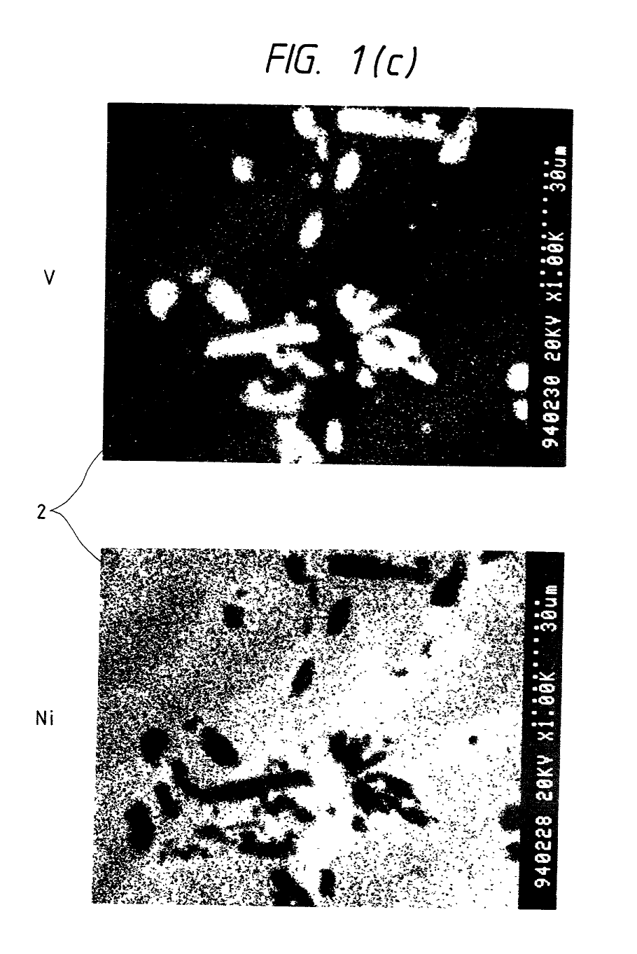

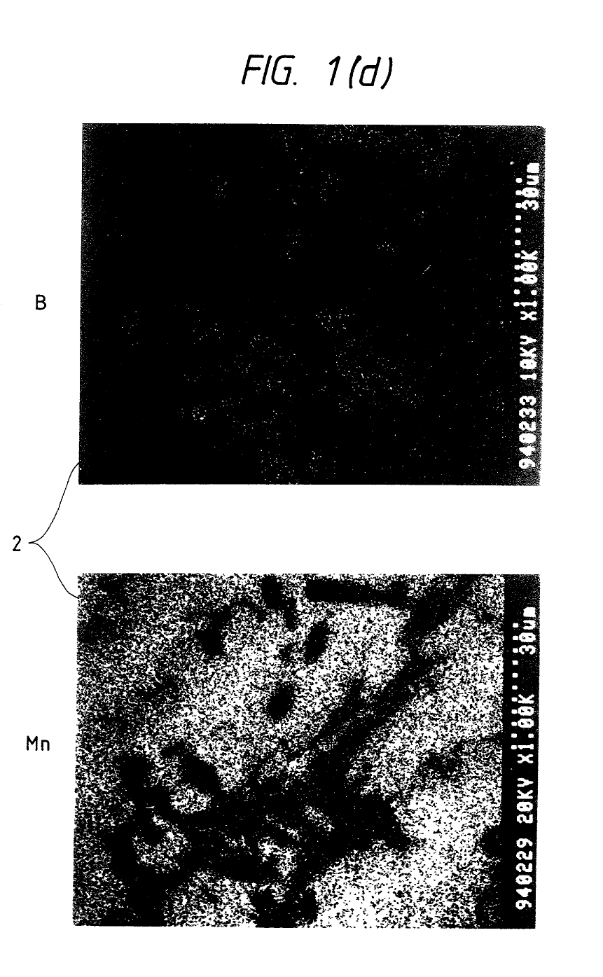

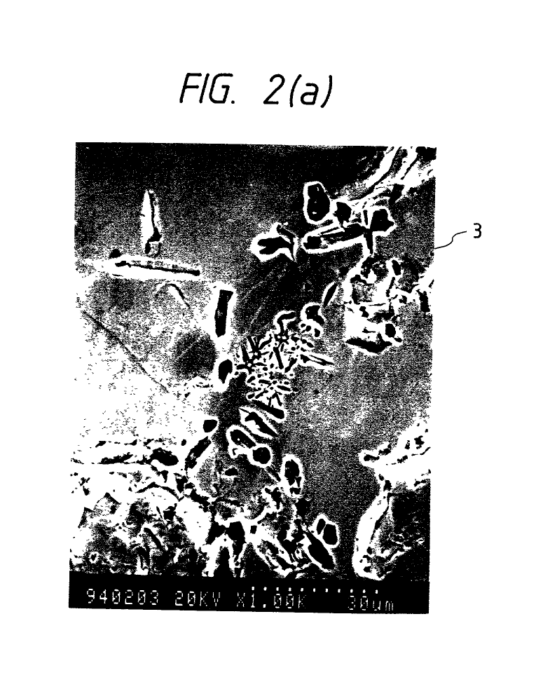

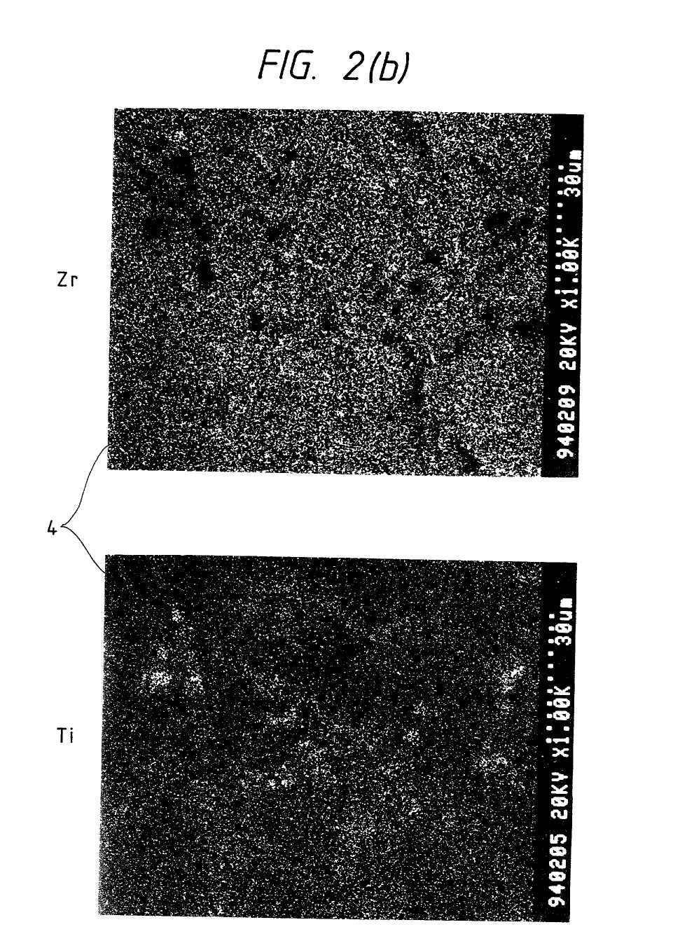

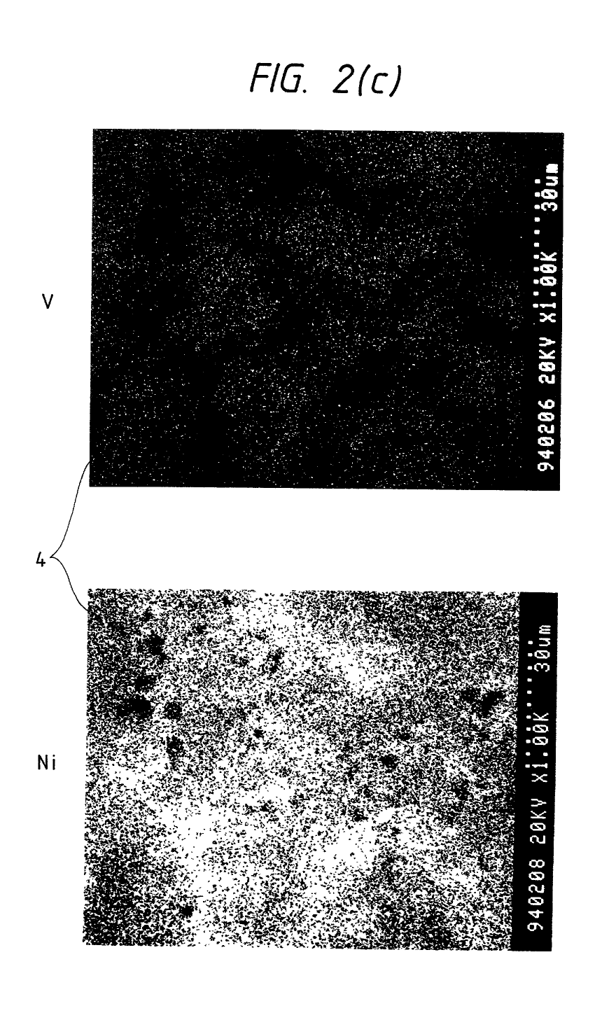

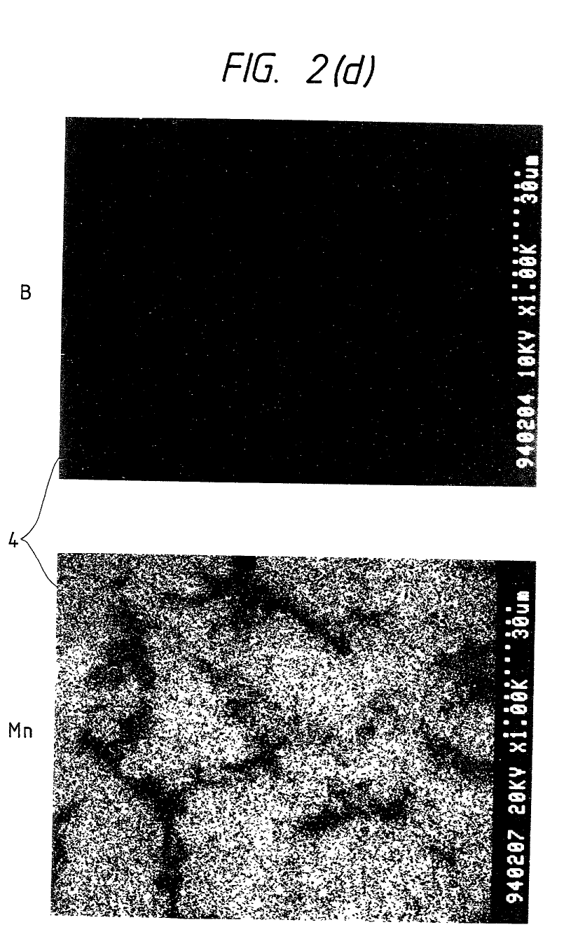

The surface of this alloy was analyzed by using a scanning type electron microscope, i.e. a wavelength dispersion type X-ray analyzer (SEM-WDX), to find out that the segregation phase of V, B and Ti having a mean diameter of 5 microns was formed. FIGS. 1(a) to 1(d) show the distribution state. This alloy powder was subjected to dissolution treatment with an aqueous solution of 30 wt % KOH, was sufficiently rinsed with water, and the powder was observed with the SEM-WDX. The result is shown in FIGS. 2(a) to 2(d).

A discontinuity of the composition with the circumferential phase formed from the difference in the dissolution velocities of the elements, where Ti is left in the pores, was observed, but V and B in the segregation phase having a mean diameter of 5 microns were completely dissolved.

The rate of the pores occupying the powder was 15% of the particle surface area, and was 5% of the particle volume, respectively. The same result as a treatment with a hot KOH aqueous solution was obtained by reaction and evaporation of the segregation in the atmosphere of chlorine gas or fluorine gas. Hydroxypropylmethylcelurose was added to this as a binding agent, and a foamed nickel substrate was filled and subjected to a roller press to obtain a metal hydride electrode of a specified thickness. An electrode of the paste type using 95% porosity of foamed nickel for the electrode substrate was used for the nickel electrode.

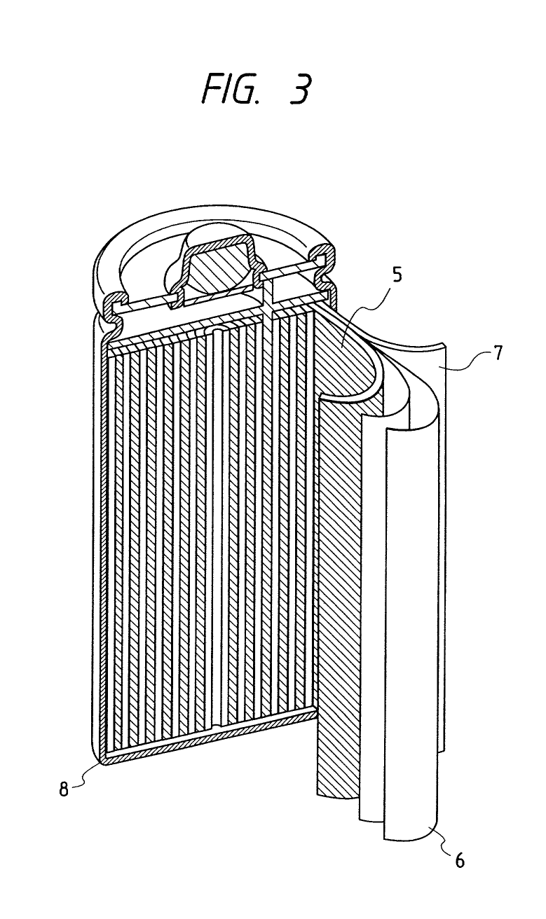

Closed type nickel-metal hydride batteries of the size AA cell type were manufactured using these electrodes. FIG. 3 shows the construction. The positive electrode and negative electrode were manufactured by winding them together with a separator of non-woven cloth made of a polypropylene resin having a thickness of 0.17 mm.

The wound electrodes were disposed in a cell casing. A small quantity of lithium hydroxide was added to an electrolyte of an aqueous solution containing 31 wt % of potassium hydroxide. The cell capacity was designed to be 1400 mAh. The cell was charged to 150% of capacity in 0.3 CmA to 3 CmA at room temperature. After keeping it for one hour, the cell was discharged to 1.0 V of the end voltage in 0.2 CmA and 3 CmA.

Setting the discharge capacity to 100, wherein the discharge capacity of a cell after charging it at 0.3 CmA and discharging it at 0.2 CmA is measured, a ratio of the discharge capacity of a cell after charging it at 3 CmA and discharging it at 0.2 CmA, and a ratio of the discharge capacity after charging it at 0.3 CmA and discharging at 3 CmA were measured, respectively. The discharge capacity of the cell was 1450 mAh at the 0.2 CmA discharge after charging at 0.3 CmA, and the cycle life of the cell was 520 times.

When the cell is charged at 0.3 CmA, and is fast discharged at 3 CmA, a discharge capacity of 95% was obtained. When the cell is charged at 3 CmA, and is discharged at 0.2 CmA, a discharge capacity of 95% of the full discharge capacity (1450 mAh) was obtained. This cell was able to discharge for 15 minutes or more with an output of 580 W/l, and was able to discharge at 200 W/l by 90% or more of the discharge capacity when charged at 300 W/l. (Comparative example 1) As a negative electrode, a hydrogen storage metallic alloy (Ti_{0.2}Zr_{0.8}Ni_{1.1}Mn_{0.6}V_{0.2} alloy) was used. The alloy components were melted at a temperature between 1100 and 1500° C. and was subjected to homogeneous treatment for 3 to 10 h at 1050° C. in an argon gas atmosphere.

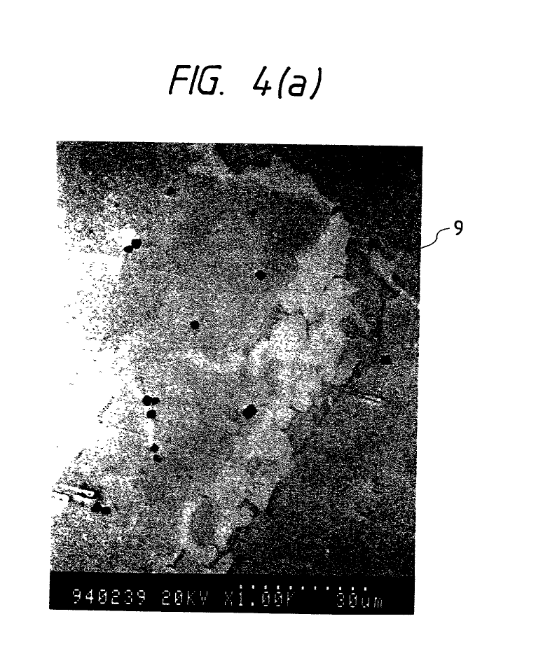

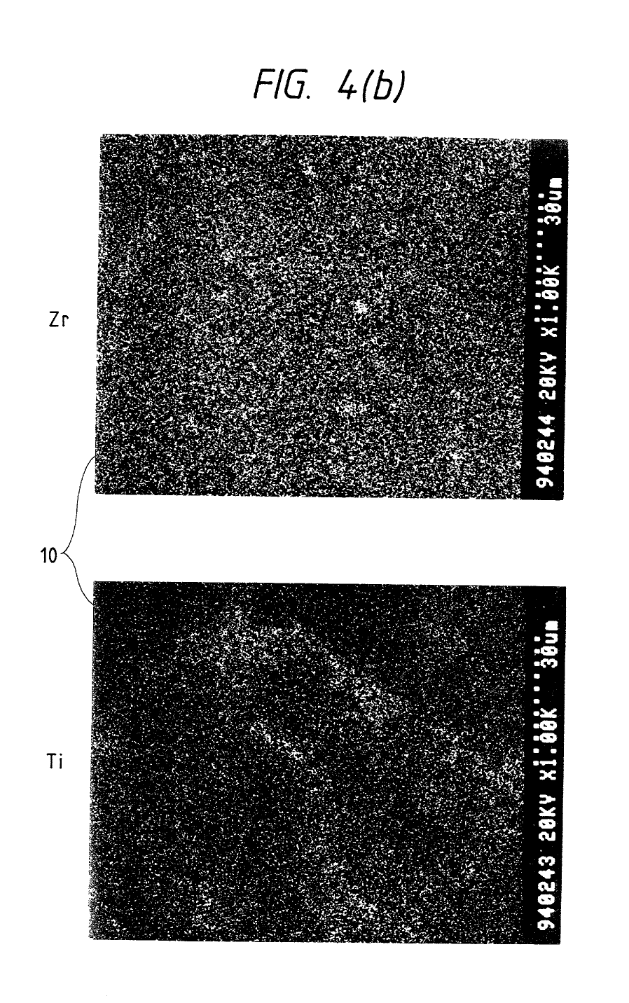

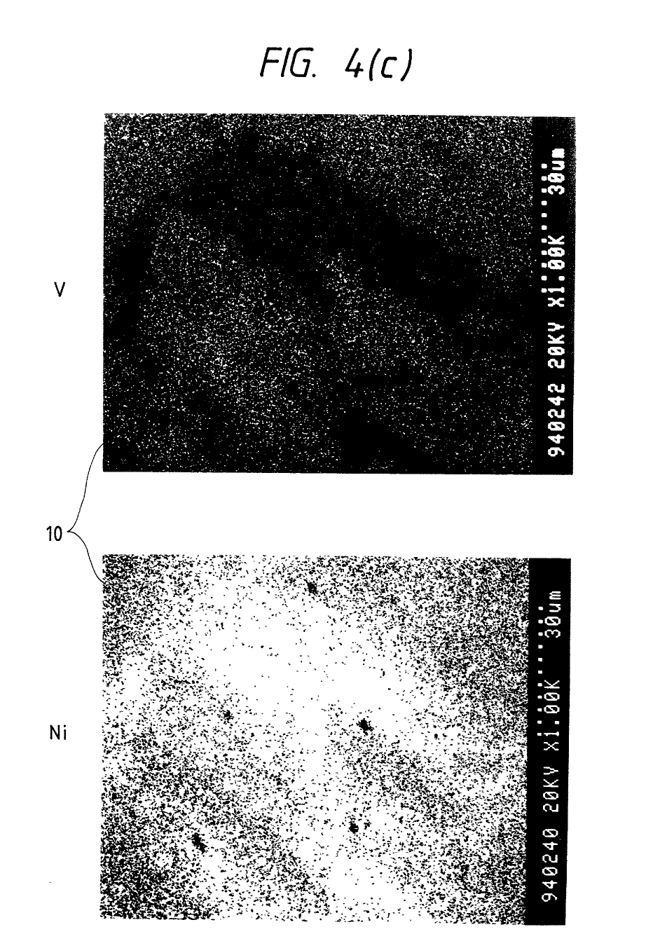

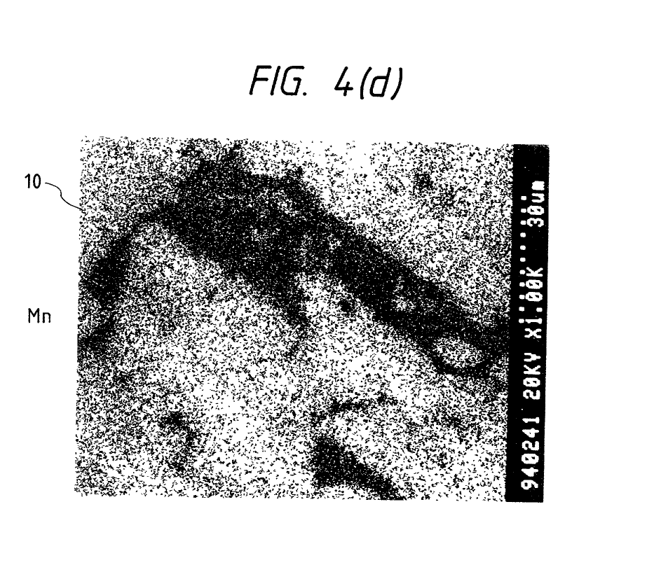

The alloy was crushed to form particles of an average particle size of 50 micron. The surface of this alloy was analyzed by using a SEM-WDX. While the second phase of the Ti and Ni was formed, the segregation phase was not detected. FIGS. 4(a) to 4(d) show the distribution state. The dissolution was attempted in the same condition as example 1.

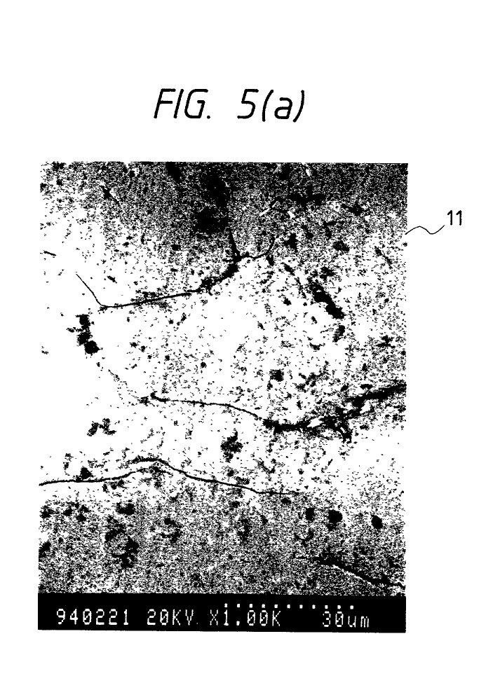

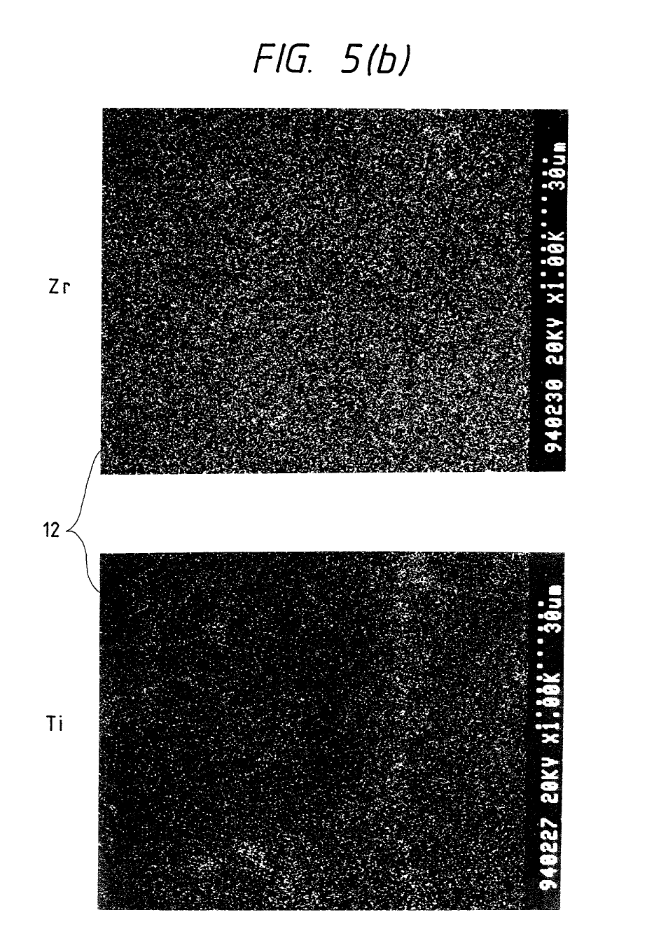

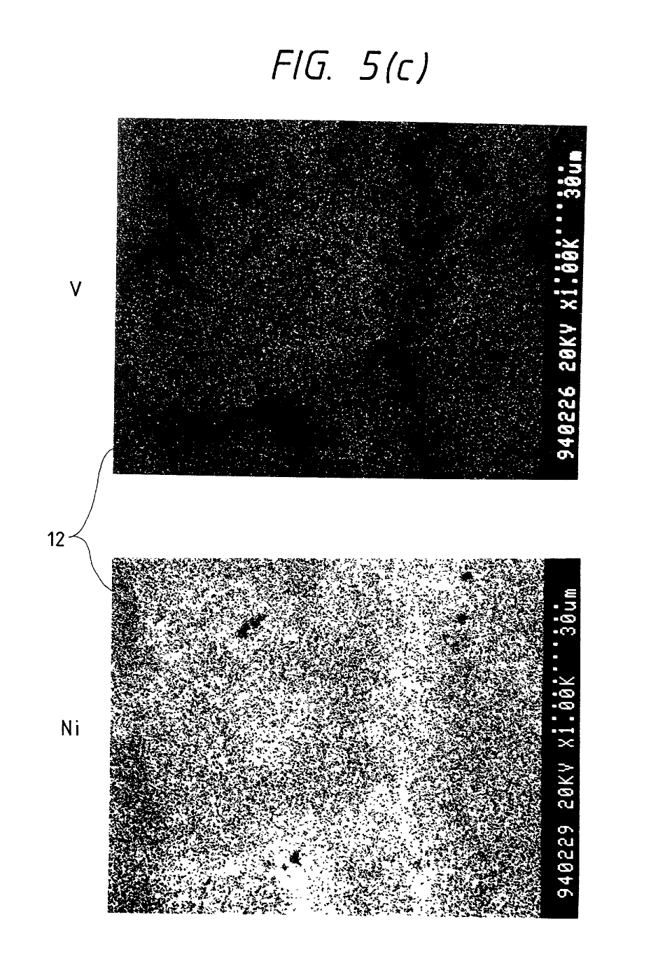

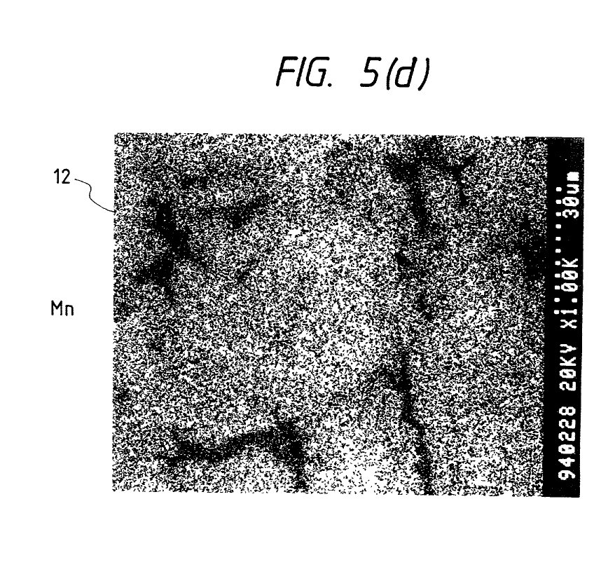

FIGS. 5(a) to 5(d) show that there was no appearance of pores as a result of the dissolution. As in example 1, an electrode was manufactured. The closed type nickel-metal hydride cell of the size AA cell type was manufactured, and the discharge capacity of the cell was measured. The discharge capacity of the cell was 1410 mAh when it discharges at 0.2 CmA after charging at 0.3 CmA, and the cycle life was only 380 times. The discharge capacity of the cell was 45% at the time of a 3 CmA discharge and was 56% at the discharge capacity at 3 CmA.

### COMPARATIVE EXAMPLE 2

As a negative electrode, the metallic alloy for hydrogen storage Ti_{0.2}Zr_{0.8}Ni_{1.1}Mn_{0.6}V_{0.2} was used. As in comparative example 1, an alloy powder of 50 micron average particle size was manufactured. The hydroxypropylmethylcelurose was added to the powder as a binding agent to fill the foamed nickel substrate, and it was molded to a specified thickness by the roller press while applying a pressure. 100 micron holes were opened on both sides of the molded body at a rate of 100/cm² to this molded, and an electrode was prepared.

As in example 1, a closed type nickel-metal hydride cell of the size AA cell type was manufactured, and its discharge capacity was measured. The discharge capacity at 0.2 CmA after charging at 0.3 CmA was 1250 mAh, and the cycle life was only 325 times. The discharge capacity at 3 CmA was 72%, and the charge capacity at 3 CmA was 70%.

### COMPARATIVE EXAMPLE 3

As a negative electrode, the metallic alloy for hydrogen storage Ti_{0.2}Zr_{0.8}Ni_{1.1}Mn_{0.6}V_{0.2} was used. This was done in a way similar to comparative example 1, and an alloy grain of 50 micron average grain size was manufactured. The hydroxypropylmethylcelurose as a binding agent and lane nickel catalyst powder were added to the powder. The mixture was filled in the foamed nickel substrate, and it was pressure-molded to a specified thickness by the roller press. As in example 1, a closed type nickel-metal hydride cell of the size AA cell type was manufactured, and the discharge capacity was measured. The discharge capacity at 0.2 CmA after charging at 0.3 CmA was 1350 mAh, and the cycle life was 383 times. It was 72% at a discharge of 3 CmA and 68% capacity at a charge of 3 Cm mA.

### EXAMPLE 2

The metallic alloy for hydrogen storage Ti_{0.2}Zr_{0.8}Ni₁₁Mn_{0.6}V_{0.2}B_{0.03} was used as a negative electrode. This alloy was melted at a temperature between 1100 and 1500° C., and the alloy was subjected to homogeneous treatment for 3 to 10 h at 800° C. in the argon gas atmosphere.

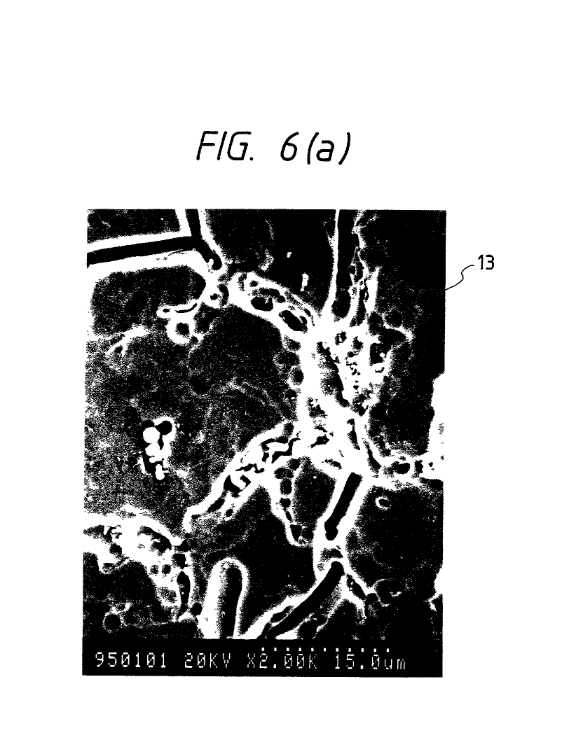

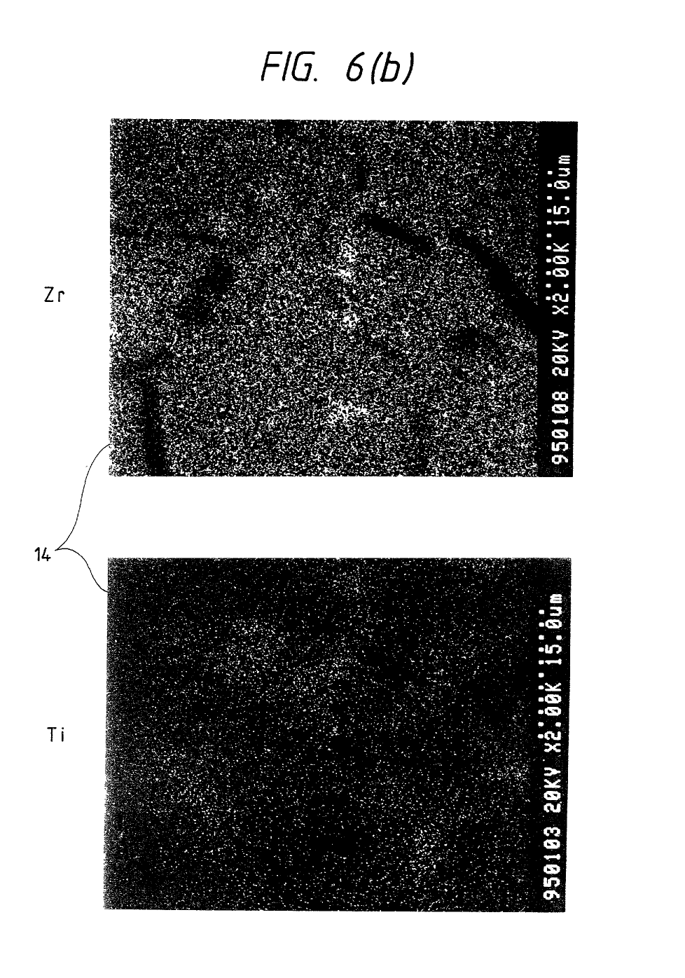

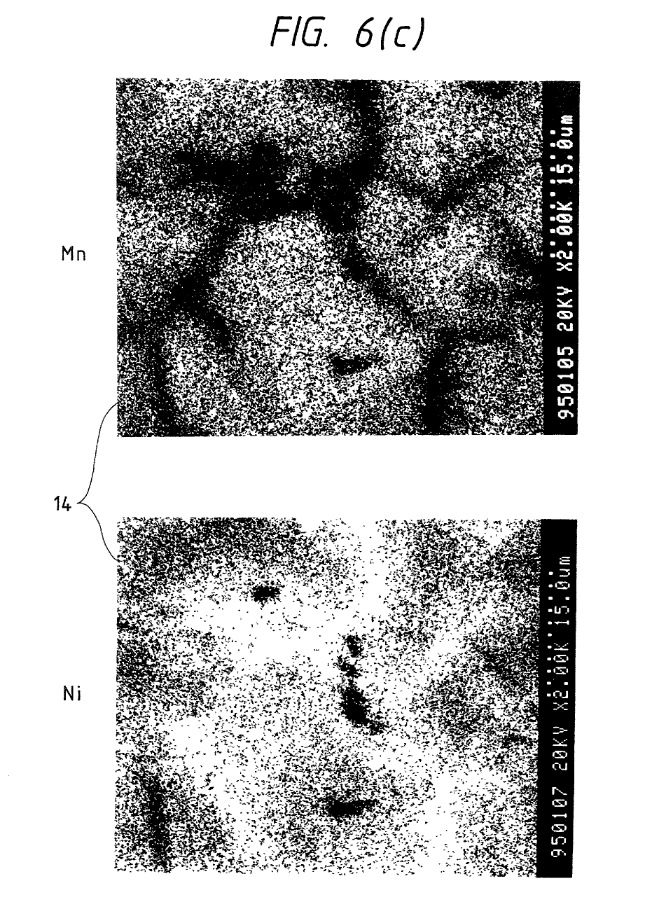

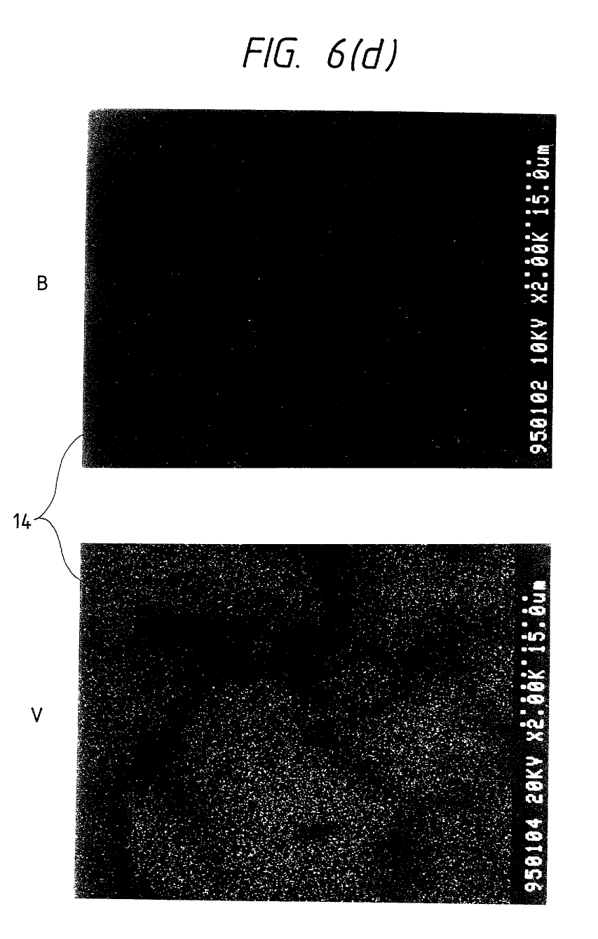

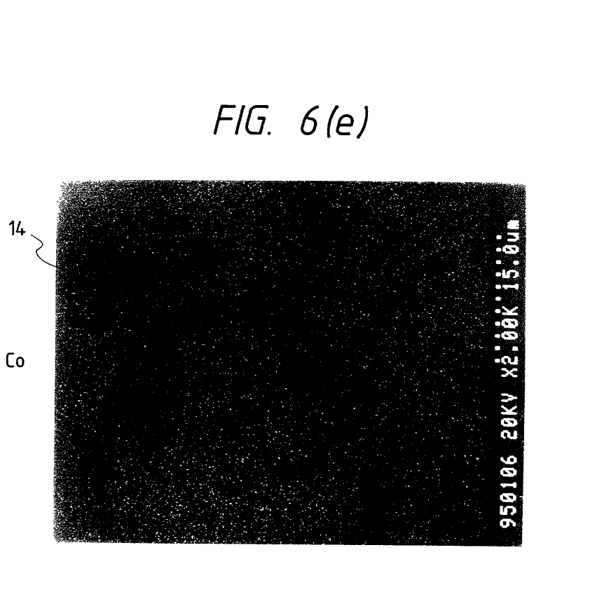

The alloy was crushed to form particles with an average particle size of 50 microns. When analyzing the surface of this alloy by using SEM-WDX, four kinds of segregation phases were observed. FIGS. 6(a) to 6(e) show the distribution state. There were four kinds of segregation phases of Zr precipitate, TiNi, Ti₂Ni and B, V and Ti. The discharge capacities of TiNi and Ti₂Ni were 150 mAh/g and 200 mAh/g, respectively. The discharge capacity of the mother phase of Ti_{0.2}Zr_{0.8}Ni_{1.1}Mn_{0.6}V_{0.2} was 330 mAh/g. The discharge capacity ratio of (mother phase)/(TiNi) was 2.2, and the discharge capacity ratio of (mother phase)/(Ti₂Ni) was 1.65, respectively.

Expansion coefficients of the lattice volume after charging that were obtained from the measurement of the x-ray diffraction of TiNi, Ti₂Ni and the mother phase (Ti_{0.2}Zr_{0.8}Ni_{1.1}Mn_{0.6}V_{0.2}) were 10%, 18%, 2 and 22%, respectively. The ratio of the expansion coefficients of (mother phase)/(TiNi) was 2.2, and the ratio of expansion coefficients of (mother phase)/Ti₂Ni was 1.22.

After subjecting the alloy to dissolution for 2 h at 70° C. with a mixed solution consisting of (30 wt % KOH aqueous solutions and aqueous solution of 1 wt % NaBH₄) and (aqueous solution of 5 wt % CH₃COOH), this alloy was sufficiently rinsed with water.

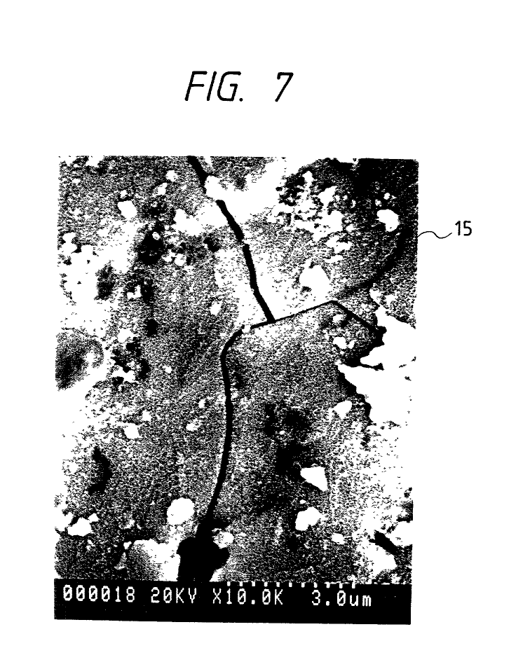

V and B were dissolved completely in the segregation phase of B, V and Ti of 1 micron mean diameter, and Ti remained in the pores. The discontinuity of the composition from the circumferential phases that arises from the difference in solubility speed due to elements was observed. In addition, as shown in FIG. 7, when; observing the alloy grains with a SEM, several fine cracks were observed in the grains.

The rate of the pores occupies 5% of the grain surface area and 0.2% of the grain volume. As in example 1, the electrode was manufactured and a closed type nickel-metal hydride cell of the size AA battery type was manufactured, and then the discharge capacity was measured. The discharge capacity under discharge at 0.2 CmA after charging at 0.3 CmA was 1470 mAh, and the cycle life was 550 times.

A discharge capacity under discharge at 3 CmA was 95% and a discharge capacity under charge at 3 CmA was 90%. The cell was able to discharge for 15 minutes at 580 W/l.

### COMPARATIVE EXAMPLE 4

As a negative electrode, a metallic alloy for hydrogen storage (Ti_{0.2}Zr_{0.8}Ni_{1.1}Mn_{0.6}V_{0.2}) was used. The alloy elements were melted at a temperature between 1100 and 1500° C. and cooled at the cooling rate of 100° C./sec. When analyzing the surface of this alloy by using a SEM-WDX, four kinds of segregation phases were observed. There were four kinds of segregation phases of the Zr deposits, i.e. Ti and Ni, V and Ti and V deposition phase.

The observation by X-ray diffraction and TEM-EPMA of minute portions revealed that the segregation phases consisting of Ti and Ni and V and Ti were phases from the amorphous state to microcrystals, which are very low in crystallinity. This alloy was crushed to form particles of 50 microns average grain size. As in example 1, a closed type nickel-metal hydride cell of the size AA battery type was manufactured, and the discharge capacity was measured.

The discharge capacity at the time of discharge at 0.2 CmA after charging at 0.3 CmA was 1150 mAh, and the cycle life was 383 times. The discharge capacity at the time of discharge at 3 CmA was 72% and was 68% at the time of charging at 3 CmA.

### EXAMPLE 3

In this example, graphite powder, which is a carbon material, was used as a negative electrode. The average grain size of the graphite powder was 0.1 micron or less, and 0.2 weight % of copper powder of 0.01 micron was added to this graphite powder and the mixture was heat-treated for 5 h at 3000° C. while mixing. Then, the graphite powder was crushed to obtain the desired powder. After subjecting this to dissolution treatment for 2 h at 70° C. in nitric acid aqueous solution and rinsing in water, the powder was analyzed by using a SEM-WDX. The pores of 0.01 to 0.05 micron average grain size and a trace of the copper were confirmed.

In other than the dissolution processing in a hot KOH aqueous solution, the same result was obtained by reacting the deposit phases, thereby to effect evaporation in the stream of chlorine gas or fluorine gas to form the deposition phase. The fluorine containing binder was added to the graphite powder, and it was coated on the copper foil. The coating and the copper foil were molded by the roller press to obtain a carbon electrode of a predetermined thickness.

The electrode in which LiCoO₂ is the principal component was used as a positive electrode. By using these electrodes, the closed type lithium cell of the size AA battery type was manufactured to measure its discharge capacity. The battery capacity was designed as 600 mAh. The discharge capacity under discharging at 0.2 CmA after charging at 0.3 CmA was 650 mAh, and the cycle life was 520 times. 92% of discharge at a discharge of 3 CmA and 89% of the discharge capacity at a charge of 3 CmA were obtained. And, 15 minutes or more of discharge with an output of 580 W/l was possible.

### COMPARATIVE EXAMPLE 5

In this comparative example, graphite powder was used as a negative electrode. The average grain size of the graphite powder was 0.1 micron or less. The graphite powder was heat-treated for 5 h at 3000° C. under mixing. The surface of the graphite powder was analyzed by using a SEM-WDX. While dissolution processing was done in the same condition as example 2, the pores were not observed.

The fluorine containing binder was added to the graphite powder, and was applied on the copper foil. Then, the coating and the copper foil were molded by the roller press to obtain a carbon electrode of predetermined thickness. The electrode, of which the principal component is LiCoO₂, was used as a positive electrode. By using these electrodes, a closed type lithium cell of the size AA battery type was manufactured, and the discharge capacity was measured.

The battery capacity was designed as 600 mAh. The discharge capacity at discharge of 0.2 CmA after the charge at 0.3 CmA was 550 mAh, and the cycle life was 420 times. 72% of discharge capacity at a discharge of 3 CmA and 69% of discharge capacity at a charge of 3 CmA were obtained.

### EXAMPLE 4

Graphite powder was used as a negative electrode. The average grain size of the graphite powder was 0.1 micron or less, and 0.2 weight % of the copper powder of 0.01 micron grain size was added to the graphite powder, and then the mixture was heat-treated for 5 h at 3000 while mixing. The mixture was crushed, and the grains called for by the present invention were obtained. 0.2 weight % of silver powder having a particle size of 0.01 micron was mixed with the graphite powder by a ball mill operating at 250 rpm.

By the mixed solution of 2 wt % formalin aqueous solutions and 5 wt % of aqueous ammonia solutions, the mixture was subjected to dissolution treatment for 2 h at 60° C. It was confirmed with a SEM-WDX that there were pores of 0.01 to 0.05 micron average grain size, a trace of copper and a deposit of silver.

A fluorine containing binder was added to the mixture, and this was applied on a copper foil. The coating and the copper foil were molded by use of a roller press to obtain a carbon electrode of the predetermined thickness. The electrode of which principal component is LiCoO₂ was used as a positive electrode. By using these electrodes, a closed type lithium cell of the size AA battery type was manufactured, and the discharge capacity was measured. The battery capacity was designed as 600 mAh. The discharge capacity at discharge of 0.2 CmA after charging at 0.3 CmA was 680 mAh, and the cycle life was 570 times. 94% of the discharge capacity for a discharge of 3 CmA, and 91% of the discharge capacity was obtained for a charge of 3 CmA, and 15 minutes or more of discharge at 580 W/l was possible.

When disassembling the cell and observing the carbon grain with a SEM, several fine cracks were observed in the silver grain. From a measurement by X-ray diffraction, the peak of LiAg was observed. The expansion coefficient of Ag at this time was 18%, and the expansion coefficient of carbon was 25%. The discharge capacity of Ag alone was 150 mAh/g, and the discharge capacity of carbon of the mother phase was 370 mAh/g. The discharge capacity ratio of (mother phase)/(Ag) was 2.47. The ratio of the expansion coefficients of the lattice volumes after charging of (mother phase)/(Ag) obtained by measurement by X-ray diffraction was 1.39.

### EXAMPLE 5

In this example, lithium-cobalt oxide was used as a positive electrode. This oxide was crushed to 1 micron or less average grain size. 0.2 weight % of Al powder having 0.1 micron grain size was added to the oxide powder and the mixture was heat-treated for 5 h at 300° C. while mixing. This mixture was crushed to obtain the desired powder. After subjecting the powder to dissolution treatment with an aqueous solution of KOH at 2 h for 70° C., the powder was rinsed with water, and then it was analyzed by using a SEM-WDX. It was confirmed that the particles had pores of average grain size of 0.2 micron.

The deposition phase was reacted in a flow of chlorine gas or fluorine gas to evaporate it, and the same result as mentioned above was obtained. The fluorine containing binder was added to this, and the mixture was applied on Al foil, and an electrode of the predetermined thickness was obtained by the roller press.

As a negative electrode, a carbon negative electrode was used. A closed type lithium cell of the size AA battery type was manufactured by using these electrodes, and its discharge capacity was measured. The battery capacity was designed as 600 mAh. The discharge capacity at a discharge of 0.2 CmA after a charge at 0.3 CmA was 710 mAh, and the cycle life was 580 times. 85% of the discharge capacity at a discharge of 3 CmA, and 80% of the discharge capacity for a charge of 3 CmA were obtained, and 15 minutes or more of discharge at an output of 580 W 1 was possible.

### COMPARATIVE EXAMPLE 6

In this comparative example, a lithium—cobalt oxide was used as a positive electrode. The oxide was crushed to 1 micron or less average grain size and was heat-treated for 5 h at 300° C. while mixing. While dissolution processing was done in the same condition as example 3, the pores were not formed when this surface was analyzed by using a SEM-WDX.

A fluorine containing binder was added to this powder, and the mixture was applied on the Al foil and was molded by a roller press to manufacture a carbon electrode of predetermined thickness. As a negative electrode, a carbon negative electrode was used. A closed type lithium cell of the size AA battery type was manufactured by using these electrodes, and the discharge capacity was measured. The discharge capacity of the cell at the time of a discharge of 0.2 CmA after a charge of 0.3 CmA was 570 mAh, and the cycle life was 380 times. 65% of the discharge capacity at a discharge of 3 CmA and 57% of the discharge capacity at a charge of 3 CmA were obtained.

### EXAMPLE 6

A lithium-cobalt-oxide was used as a positive electrode. This was crushed to a powder of 1 micron or less average grain size. 2 weight % of 0.1 micron Al powder and 2 wt % of V powder were added to the powder and heat-treated for 15 h at 370° C. while mixing. Then the mixture was crushed to obtain grains of a desired particle size. After subjecting this to dissolution for 1 h at 70° C. in a 15 wt % KOH aqueous solution and rinsing it with water, the powder was processed for 1 hour at 40° C. in a mixture solvent of ethylenecarbonate and dimethoxyethane. It was determined by using a SEM-WDX that a deposit of V, pores of an average grain size of 0.1 micron, a trace of Al and a mother phase of LiCo₁₋ₓVxO₂(x=0 to 0.5) were formed.

A fluorine containing binder was added to this, and the mixture was applied to an Al foil. The coating and the foil were molded by a roller press to obtain an electrode of predetermined thickness. As a negative electrode, a carbon negative electrode was used. A closed type lithium cell of the size AA battery type was manufactured by using these electrodes, and the discharge capacity was measured. The battery capacity was designed as 600 mAh. The discharge capacity at a discharge of 0.2 CmA after a charge of 0.3 CmA was 750 mAh, and the cycle life was 640 times. Also, 88% of the discharge capacity at a discharge of 3 CmA, and 85% of discharge capacity at a charge of 3 CmA were obtained, and 15 minutes or more of discharge with an output of 580 W/l was possible. When disassembling the cell and doing a SEM observation of the grain, several fine cracks were observed in the V deposition grain, and from the measurement by X-ray diffraction, the peak of LiₓV_{y}O₂ was observed.

The expansion coefficient of the V deposit at this time was 14%, and the expansion coefficient of the mother phase was 20%. The discharge capacity of the LiₓV_{y}O₂ by itself was 50 mAh/g, and the discharge capacity of the mother phase was 150 mAh/g. The discharge capacity ratio of (mother phase)/(LiₓV_{y}O₂) is 3.0. The ratio of the expansion coefficient of the lattice volumes of (mother phase)/(LiₓV_{y}O₂) after the charge obtained from the measurement by X-ray diffraction) is 1.43.

### EXAMPLE 7

A hydrogen storage alloy (Ti_{0.2}Zr_{0.8}Ni_{1.1}Mn_{0.6}V_{0.2}) was used as a negative electrode. 0.01 from 0.1 in the atom ratio of boron having an average grain size of 10 to 0.1 micron was added to the alloy to produce an alloy in the same manner as in example 1.

The alloy was crushed to obtain grains of 50 micron average grain size. As in example 1, pores were formed. The average size of the pores was 25 to 0.4 microns (½ to 1/150 of the average grain size of the alloy). In the same manner as in example 1, an electrode was manufactured to assemble a closed type nickel-metal hydride cell of the size AA battery type, and the discharge capacity was measured. As in example 1, the electrode was manufactured, a closed mold nickel-metal hydride cell of the size AA battery type was manufactured, and the discharge capacity was measured.

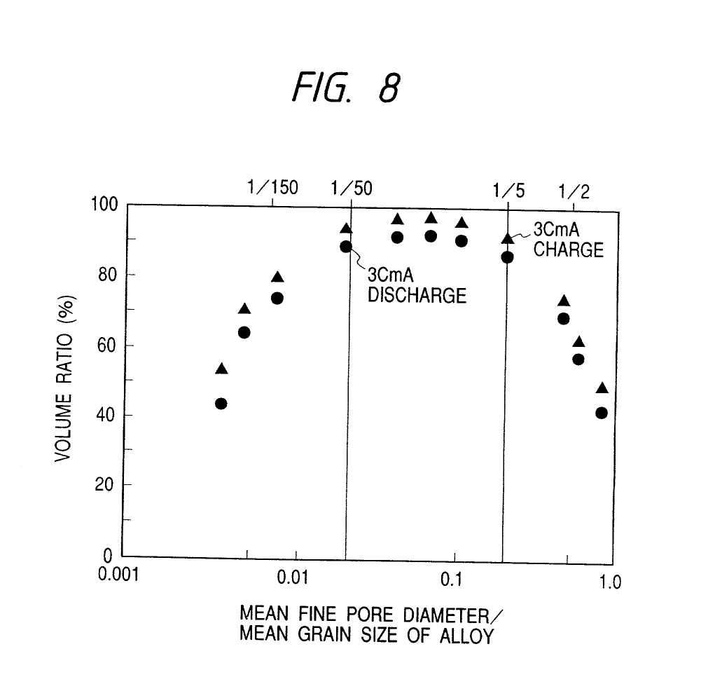

FIG. 8 shows a relationship between the average grain size of the pores and the ratio of the discharge capacity at the charge of 3 CmA against the discharge capacity of 3 CmA. The discharge capacity of a discharge at 0.2 CmA after a charge of 0.3 CmA was 1100 to 920 mAh, and the cycle life was 680 to 500 times. The discharge capacity of the cell was 95 to 75% at a discharge of 3 CmA, and the discharge capacity of a discharge after a charge of 3 CmA was 98 to 75%. This cell was able to discharge for 15 minutes or more at an output of 580 W/l. The mean diameter of the pores was ⅕ to 5/50 of the average grain size of the alloy, and the cell had a large discharge capacity.

### COMPARATIVE EXAMPLE 7

The metallic alloy for hydrogen storage (Ti_{0.2}Zr_{0.8}Ni_{1.1}Mn_{0.6}V_{0.2}) was used as a negative electrode. An atomic ratio of 0.1 of boron powder having a 0.05 micron average grain size was added to this alloy, and like example 1, an alloy was manufactured. The alloy was crushed to other grains of 50 micron average grain size. As in example 1, pores were formed in the electrode. The mean diameter of the pores was 0.3 microns or less (smaller than 1/150 of the average grain size of the alloy).

As in example 1, the electrode was manufactured, and a closed type nickel-metal hydride cell of the size AA battery type was manufactured to measure the discharge capacity.

FIG. 8 shows the relation between the mean diameter of the pores and the capacity ratio of the discharge capacity at a charge of 3 CmA to that at a discharge of 3 CmA. The discharge capacity at a discharge of 0.2 CmA after a charge of 0.3 CmA was 950 to 910 mAh, and the cycle life was 520 to 480 times. But, the discharge capacity at a discharge of 3 CmA was 45 to 65% and the discharge at a charge of 3 CmA was 55 to 68%.

### COMPARATIVE EXAMPLE 8

The hydrogen storage alloy (Ti_{0.2}Zr_{0.8}Ni_{1.1}Mn_{0.6}V_{0.2}) was used as a negative electrode. An atomic ratio of 0.1 of boron of 15 microns average grain size was added to the alloy. As in example 1, the alloy was manufactured. The alloy was crushed to obtain grains of 50 microns average grain size.

Like example 1, pores were formed in the alloy. The mean diameter of the pores was 30 microns or more (larger than ½ of the mean grain size of the alloy). As in example 1, the electrode was manufactured, and a closed type nickel-metal hydride cell of the size M battery type was manufactured to measure the discharge capacity.

FIG. 8 shows a relationship between the mean diameter of the pores and the ratio of the discharge capacity at a charge of 3 CmA against the discharge capacity of the discharge of 3 CmA. The discharge capacity at a discharge of 0.2 CmA after a charge of 0.3 CmA was 970 to 920 mAh, and the cycle life was 500 to 450 times. The discharge capacity at a discharge of 3 CmA was 45 to 63%, and the discharge capacity at a charge of 3 CmA was 66 to 48%. (Example 83 A hydrogen storage alloy (Ti_{0.2}Zr_{0.8}Ni_{1.1}Mn_{0.6}V_{0.2}Bₓ (x=0.01 to 0.8) was used as a negative electrode, and pores were formed in the alloy, as in example 1. The rate of the pores was 5 to 80% to the grain surface, and the rate of grain volume was 0.2 to 60%, respectively. Like example 1, the electrode was manufactured, and a closed type nickel-metal hydride cell of the size AA battery type was manufactured to measure the discharge capacity.

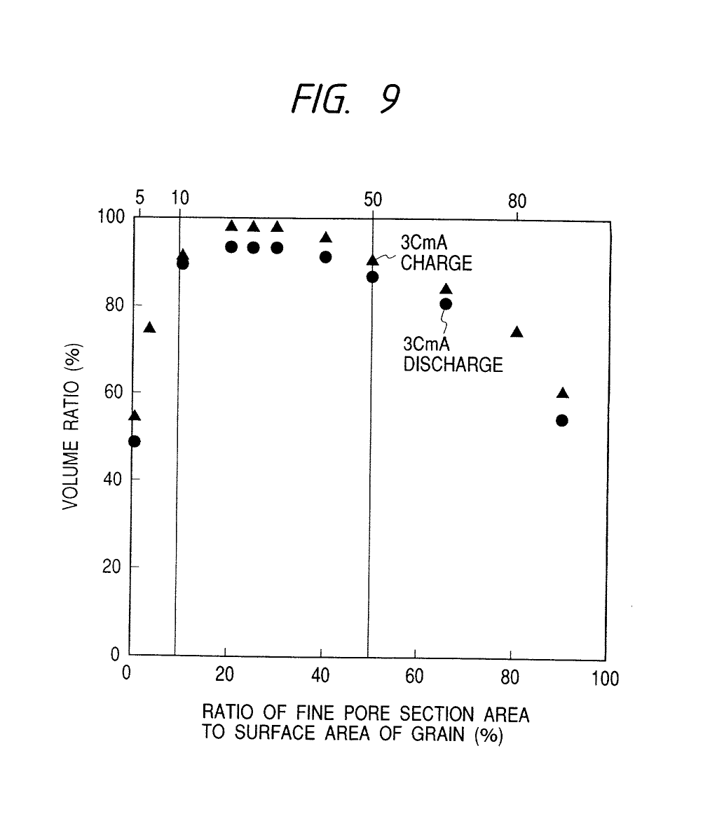

FIG. 9 shows a relationship between the ratio of the sectional area of the pores against the grain surface area and the ratio of the discharge capacity at a charge of CmA with respect to the discharge capacity at a discharge of 3 CmA.

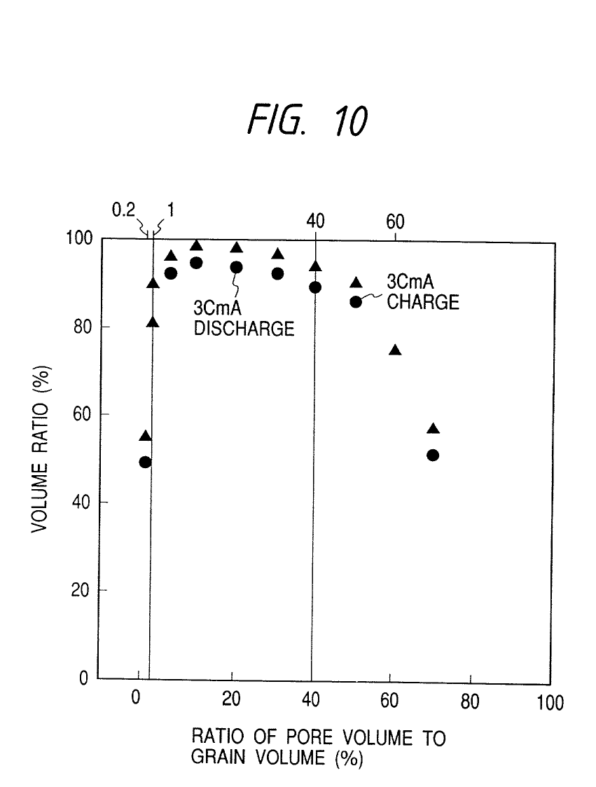

FIG. 10 shows a relationship between the ratio of the volume of the pores against the grain volume and the ratio of the capacity at a charge of 3 CmA against a discharge capacity of 3 CMA. The capacity at discharge of 0.2 CmA after a charge of 0.3 CmA was 1550 to 1420 mAh, and the cycle life was 580 to 430 times. Also, 95 to 75% of the discharge capacity was obtained at the discharge of 3 CmA, and 98 to 75% of the discharge capacity was obtained at a charge of 3 CmA.

When the ratio of the pore surface to the grain surface area was 10 to 50% or when the ratio of the pore volume to the grain volume was 1 to 40%, the discharge capacity was especially large.

### COMPARATIVE EXAMPLE 9

The hydrogen storage alloy (Ti_{0.2}Zr_{0.8}Ni_{1.1}Mn_{0.6}V_{0.2}Bₓ (x=0.001 to 0.005,) was used as a negative electrode. Like example 1, pores were formed in the alloy. The rate of the pore area to the grain surface area was 0.3%, and the rate of the pore volume to the grain volume was 0.1%. By using this material, as in example 1, the electrode was manufactured. A closed type nickel-metal hydride cell of the size AA battery type was manufactured to measure the discharge capacity.

FIG. 9 shows a relationship between the ratio of the sectional area of the pores to the grain surface area and the ratio of the discharge capacity at a charge of 3 CmA to the discharge capacity of 3 CmA.

FIG. 10 shows a relationship between the ratio of the pore volume to the grain volume and the ratio of the discharge capacity at the discharge of 3 CmA to the charge capacity of 3 CmA. The capacity at a discharge of 0.2 CmA after a charge of 0.3 CmA was 1400 mAh, and the cycle life was 320 times. Also, 50% of the discharge capacity at a discharge of 3 CmA and 55% of the discharge capacity at the charge of 3 CmA were obtained.

### COMPARATIVE EXAMPLE 10

The hydrogen storage alloy (Ti_{0.2}Zr_{0.8}Ni_{1.1}Mn_{0.6}V_{0.2}Bₓ (x=10 to 1.8) was used as a negative electrode. As in example 1, pores were formed in the alloy. The ratio of the sectional area of the pores to the grain surface area was 90%, and the ratio of the pore volume to the grain volume was 70%. Using this material, as in example 1, the electrode was manufactured, and a closed type nickel-metal hydride cell of the size AA battery type was manufactured to measure the discharge capacity.

FIG. 9 shows a relationship between the ratio of the pore sectional area to the grain surface area and the ratio of the discharge capacity at 3 CmA charge to the capacity of 3 CmA discharge.

FIG. 10 shows a relationship between the ratio of the pore volume to the grain volume and the ratio of discharge capacity of 3 CmA to the discharge of 3 CmA. The capacity at a discharge of 0.2 CmA after a charge of 0.3 CmA was 1120 mAh, and the cycle life was 300 times. Also, 55% of the discharge capacity at a discharge of 3 CmA and 60% of the discharge capacity at a charge of 3 CmA were obtained.

### EXAMPLE 9

The hydrogen storage alloys having the compositions shown in Table 1 were used as negative electrodes. The segregation phases were formed in the alloys. The quantities of Al, V Mn, Sn, B, Mg, Mo, W, Zr, K, Na, Li, Ni and Ti contained in the segregation phases were 30 weight % or more.

The phases were subjected to dissolution treatment for 1 h at 50° C. with aqueous solution containing an acids, alkalis, oxidizing agents and reducing agents. After washing the alloys in water, as in example 1, the electrodes were manufactured to assemble a closed type nickel-metal hydride cell of the size AA battery type. The discharge capacity of the cells was measured.

Table 1 shows the results. The discharge capacity at a discharge of 0.2 CmA after a charge of 0.3 CmA was 1510 to 1400 mAh, and the cycle life of the cells was 550 to 480 times. Also, 95 to 78% of the discharge capacity at the discharge of 3 CmA and 98 to 88% of the discharge capacity at a charge of 3 CmA were obtained.

TABLE 1

| | | 0.3 Cmλ charge-0.2 | Cycle | | |
|---|---|---|---|---|---|
| Hydrogen storage alloys | Treating liquids | Cmλ ischarge(mλh) | life (Number) | 3 Cmλ discharge(%) | 3 Cmλ charge (%) |
| (La Ce Nd Pr)-(Ni Mn Al Co)_{4, 5˜5, 5} | KOH + NaBH4 | 1460 | 510 | 91 | 98 |
| (La Ce Nd Pr)-(Ni Mn Al Co B)_{4, 5˜6, 5} | KOH + HF | 1400 | 520 | 92 | 90 |
| (La Ce Nd Pr)-(Ni Mn Al Co W)_{4, 5˜6, 5} | KOH + NaBH4 | 1400 | 520 | 88 | 88 |
| (La Ce Nd Pr)-(Ni Mn Al Co Mo)_{4, 5˜5, 6} | KOH + HF | 1410 | 510 | 95 | 90 |
| (La Ce Nd Pr)-(Ni Mn Al Co Mg)_{4, 5˜5, 5} | KOH + HF | 1480 | 500 | 94 | 98 |
| (La Ce Nd Pr)-(Ni Mn Al Co K)_{4, 5˜5, 5} | KOH + HNO3 | 1470 | 550 | 78 | 88 |
| (La Ce Nd Pr)-(Ni Mn Al Co Na)_{4, 5˜5, 5} | KOK + NaHClO | 1470 | 660 | 79 | 89 |
| (La Ce Nd Pr)-(Ni Mn Al Co Pd)_{4, 5˜5, 5} | KOH + KPH2O2 | 1490 | 480 | 80 | 95 |
| (La Ce Nd Pr)-(Ni Mn Al Co Sn)_{4, 5˜6, 5} | KOH + NaPH2O2 | 1500 | 490 | 95 | 98 |
| (La Ce Nd Pr)-(Ni Mn Al Co Fe)_{4, 5˜5, 6} | KOH + HCHO + HF | 1470 | 480 | 88 | 94 |
| (Ca La Ce Nd Pr)-(Ni Mn Al Co)_{4, 5˜5, 6} | KOH + H2O2 + HF | 1500 | 490 | 86 | 92 |
| (Zr Ti)-(Ni Mn V Co B)_{1, 5˜2, 5} | KOH + NaBH4 | 1510 | 500 | 89 | 91 |
| (Zr Ti Hf)-(Ni Mn V Co Mo)_{1, 5˜2 5} | KOH + NaOCl | 1470 | 510 | 79 | 90 |
| (Zr Ti Sc)-(Ni Mn V Co W)_{1, 5˜2 5} | KOH + HNO3 + HF | 1490 | 560 | 93 | 89 |
| (Zr Ti Mg)-(Ni Mn V Co K)_{1, 5˜2, 5} | KOH + NaBH4 | 1490 | 560 | 94 | 88 |
| (Zr Ti)-(Ni Mn V Co Pd)_{1 5˜2, 5} | KOH + H2O2 + HF | 1480 | 510 | 79 | 89 |
| (Zr Ti)-(Ni Mn V Co Sn)_{1, 5˜2, 5} | KOH + HNO3 + HF | 1480 | 550 | 81 | 97 |
| (Zr Ti)-(Ni Mn V Co Fe)_{1, 5˜2, 5} | KOH + HNO3 + HF | 1490 | 490 | 84 | 91 |
| (Zr Ti)-(Ni Mn V Co Cr)_{1 5˜2, 5} | KOH + HNO3 + HF | 1400 | 490 | 94 | 97 |
| (Zr Ti)-(Ni Mn V Co Li)_{1, 5˜2, 6} | KOH + NaBH4 | 1510 | 480 | 83 | 90 |
| (Zr Ti)-(Ni Mn V Co Fe)_{1 5˜2, 5} | KOH + HNO3 + HF | 1600 | 490 | 80 | 89 |
| (Zr Ti)-(Ni Mn V Co Cr)_{1, 5˜2, 5} | KOH + NaOCl | 1480 | 480 | 90 | 96 |
| (Zr Ti)-(Ni Mn V Co Al)_{1, 5˜2, 5} | KOH + NaPH2O2 | 1470 | 500 | 93 | 97 |
| (Zr Ti)-(Ni Mn V Co Cr Fel)_{1, 5˜2, 5} | KOH + HNO3 + HF | 1470 | 540 | 90 | 89 |
| (Zr Ti)-(Ni Mn V Co C)_{1, 5˜2, 5} | KOH + H2O2 | 1480 | 510 | 95 | 88 |
| (Zr Ti)-(Ni Mn V Co Pb)_{1, 5˜2, 5} | KOH + HNO3 + HF | 1400 | 490 | 91 | 97 |
| (Zr Ti)-(Ni Mn V Co Sn)_{1, 5˜2 5} | KOH + HNO3 + HF | 1500 | 530 | 79 | 89 |
| (Mg Zr Ti)_{2 0}-(Ni Mn V Co B)_{0, 5˜1, 5} | KOH + NaBH4 | 1470 | 480 | 78 | 89 |
| (Mg Zr Ti)_{2 0}-(Ni Mn V Co W)_{0 5˜1 5} | KOH + NaOCl | 1470 | 480 | 80 | 92 |
| (Mg Zr Ti)_{2 0}-(Ni Mn V Co Mo)_{0, 5˜1 6} | KOH + NaBH4 | 1480 | 520 | 82 | 92 |
| (Mg Zr Ti)_{2 0}-(Ni Mn V Co)_{0, 5˜1 5} | KOH + HNO3 + HF | 1560 | 540 | 91 | 97 |
| (Mg Zr Ti)_{2 0}-(Ni Mn Al Co)_{0, 6˜1 6} | KOH + H2O2 | 1480 | 530 | 95 | 98 |
| (Mg Zr Ti)_{2 0}-(Ni Mn Al Co B)_{0, 5˜1, 5} | KOH + NaBH4 | 1470 | 500 | 87 | 92 |
| (Mg Zr Ti)_{2 0}-(Ni Mn Al Co W)_{0 5˜1, 5} | KOH + HNO3 + HF | 1470 | 510 | 89 | 94 |
| (Mg Zr Ti)_{2 0}-(Ni Mn Al Co Mo)_{0, 5˜1 5} | KOH + NaPH2O2 | 1480 | 490 | 80 | 91 |

### EXAMPLE 10

A graphite powder that is a carbon material was used as a negative electrode. The graphite was crushed to obtain grains of 0.1 micron or less average grain size. Then, 0.2 weight % of 0.01 micron powder shown in Table 2 was added to this powder. Mixing the mixture for 5 h at 3000° C., it was heat-treated. Then, the mixture was crushed, and the powder of the present invention was obtained.

After dissolution treatment of this powder for 2 hours at 70° C. with a nitric acid aqueous solution and sufficiently washing this in water, it was analyzed by using a SEM-WDX. It was confirmed that pores of an average size of 0.01 micron were formed. A closed type lithium cell of the size AA battery type was manufactured similar to example 3, and the discharge capacity was measured.

Table 2 shows the results. The discharge capacity of a discharge at 0.2 CmA after a charge of 0.3 CmA was 750 to 670 mAh, and the cycle life was 520 to 480 times. It was 85 to 82% of the discharge capacity at a discharge of 3 CmA, and it was 85 to 79% of the discharge capacity at a discharge of 3 CmA.

TABLE 2

| | After 0. 3 CmA charge, | Cycle life | Discharge capacity at | Discharge capacity at |
|---|---|---|---|---|
| Additives | discharge at 0.2 CmA (mAh) | (Number) | 3 CmA discharge (%) | 3 CmA charge (%) |
| Fe | 720 | 510 | 85 | 84 |
| Ni | 690 | 490 | 82 | 85 |
| S | 700 | 490 | 82 | 84 |
| Si | 710 | 500 | 82 | 80 |
| Sn | 690 | 520 | 83 | 79 |
| Li | 700 | 480 | 82 | 79 |
| Na | 670 | 490 | 82 | 79 |
| K | 750 | 480 | 85 | 80 |
| Pb | 740 | 480 | 85 | 79 |
| FeOx | 700 | 520 | 84 | 80 |
| NiOx | 710 | 500 | 82 | 85 |
| SiOx | 750 | 510 | 85 | 83 |
| SnOx | 710 | 510 | 83 | 84 |
| LiOx | 670 | 490 | 84 | 82 |
| PbOx | 680 | 500 | 84 | 81 |

### COMPARATIVE EXAMPLE 11

A graphite powder was used as a negative electrode. This was crushed to obtain a powder of 0.1 micron or less average grain size. An iron powder of 0.01 micron size that is equivalent to 55 weight % of the powder was added. Mixing the mixture for 5 h at 3000° C., it was heat-treated. This was subjected to dissolution treatment for 2 h at 70° C. with a nitric acid aqueous solution. It was confirmed by using a SEM-WDX that after sufficiently washing in water, pores of an average grain size of 0.08 micron were formed. Like example 3, a closed type lithium cell of the size AA battery type was manufactured, and the discharge capacity was measured. The discharge capacity after a charge of 0.3 CmA and a discharge at 0.2 CmA was 470 mAh. The cycle life was 380 times. The charge at 3 CmA was 55 to 64%, and the discharge at 3 CmA was 57 to 72%.

### COMPARATIVE EXAMPLE 12

A graphite powder was used as a negative electrode. This was crushed to a powder of 0.1 micron or less average grain size. Thus, 0.01 weight % of 0.01 micron iron powder was added to this powder. Mixing the mixture for 5 h at 3000° C., it was heat-treated. This was processed (dissolution) for 2 hours at 70 degrees centigrade using a nitric acid aqueous solution.

After a sufficiently flushing, it was confirmed using SEM-WDX that pores of an average grain size of 0.004 micron were formed. A closed type lithium cell of the size AA battery type was manufactured like example 3, and the discharge capacity was measured. The discharge capacity at a 0.2 CmA discharge after a charge at 0.3 CmA was 670 mAh, and the cycle life was 280 times. Also, 55 to 69% was obtained at 3 CmA charge and 57 to 72% was obtained at 3 CmA discharge. [Example 11] The conductive polymer material (polyacetylene powder) was used as a positive electrode. This was crushed to a powder of 0.1 micron or less average grain size. A 0.2 weight % of 0.05 micron powder shown in Table 3 was added thereto and the mixture was mixed for 5 hours at 300 to 500° C., and the mixture was heat-treated. Then, it was crushed to obtain a powder of the desired grain size. This powder was subjected to dissolution treatment for 2 hours at 70° C. with a nitric acid aqueous solution. The powder was analyzed by using a SEM-WDX after sufficiently rinsing it with water and it was confirmed that pores of an average grain size of 0.08 micron were formed.

When reacting in the flow of chlorine gas or fluorine gas with the deposition phase to evaporate, the same result also was obtained. A fluorine containing binder was added to this, and it was applied on an Al foil. An electrode of predetermined thickness was obtained using a roller press. As a negative electrode, a carbon negative electrode was used. A closed type lithium cell of the size AA battery type was manufactured by using these electrodes, and the capacity was measured. The battery capacity was designed as 500 mAh.

Table 3 shows the result. The capacity of a 0.2 CmA discharge after a 0.3 CmA charge was as high as 640 to 570 mAh, and the cycle life was as long as 670 to 490 times. Also, 91 to 81% capacity was obtained in the discharge of 3 CmA, and 87 to 78% capacity was obtained in the charge of 3 CmA.

TABLE 3

| | After 0.3 CmA charge, | Cycle life | Discharge capacity at | Discharge capacity at |
|---|---|---|---|---|
| Additives | discharge at 0.2 CmA (mAh) | (Number) | 3 CmA discharge (%) | 3 CmA charge (%) |
| Fe | 610 | 520 | 91 | 87 |
| Ni | 640 | 500 | 88 | 84 |
| S | 620 | 490 | 82 | 86 |
| Si | 640 | 500 | 85 | 87 |
| Sn | 600 | 510 | 84 | 85 |
| Li | 570 | 670 | 81 | 84 |
| Na | 570 | 620 | 83 | 79 |
| K | 580 | 600 | 84 | 78 |
| Pb | 570 | 610 | 82 | 85 |
| FeOx | 590 | 600 | 91 | 78 |
| NiOx | 600 | 490 | 81 | 80 |
| SiOx | 620 | 500 | 85 | 84 |
| SnOx | 590 | 550 | 86 | 87 |
| LiOx | 600 | 520 | 86 | 86 |
| PbOx | 590 | 550 | 82 | 79 |

### EXAMPLE 12

The conductive polymer material (polyacene powder) was used as a negative electrode. This was crushed to a powder of average grain size of 0.1 micron or less. Then, 0.2 weight % of the powders (0.01 microns) shown in Table 4 were added to the above powder and were mixed for 5 hours at 1000 to 3000° C. for heat-treatment. This was subjected to dissolution treatment for 2 hours at 70° C. with a nitric acid aqueous solution.

The was analyzed by using a SEM-WDX after sufficient rinsing with water. It was confirmed that pores of 0.02 micron mean diameter were formed. The chlorine gas stream or the fluorine gas stream was reacted with the deposition phase to evaporate, and the same result was obtained. A fluorine containing binder was added to this, it was applied on a copper foil, and the coating and the copper foil were molded by a roller press to manufacture the electrode of predetermined thickness. The electrode of which main component is LiCoO₂ was used as a positive electrode. A closed type lithium cell of the size AA battery type was manufactured by using these electrodes, and the capacity was measured. The battery capacity was designed as 600 mAh.

Table 4 shows the result. The discharge capacity of the discharge at 0.2 CmA after a charge at 0.3 CmA was as large as 860 to 700 mAh, and the cycle life was as long as 700 to 580 times. The cell had 93 to 88% of the discharge capacity in the discharge at 3 CmA, and 90 to 82% of the discharge capacity at the charge of 3 CmA.

TABLE 4

| | After 0.3 CmA charge, | Cycle life | Discharge capacity at | Discharge capacity |
|---|---|---|---|---|
| Additives | discharge at 0.2 CmA (mAh) | (Number) | 3 CmA discharge (%) | at 3 CmA charge (%) |
| Fe | 860 | 660 | 91 | 88 |
| Ni | 760 | 700 | 88 | 90 |
| S | 740 | 650 | 90 | 82 |
| Si | 790 | 600 | 90 | 82 |
| Sn | 700 | 580 | 91 | 83 |
| Li | 710 | 600 | 88 | 85 |
| Na | 700 | 590 | 88 | 82 |
| K | 700 | 580 | 89 | 86 |
| Pb | 710 | 580 | 93 | 83 |
| FeOx | 860 | 580 | 90 | 89 |
| NiOx | 800 | 600 | 93 | 90 |
| SiOx | 810 | 660 | 92 | 88 |
| SnOx | 710 | 690 | 89 | 89 |
| LiOx | 700 | 700 | 93 | 82 |
| PbOx | 700 | 600 | 90 | 85 |

### EXAMPLE 13

The alloy shown in Table 5 was used as a negative electrode. The alloy materials were melted at a temperature between 1100 and 1500° C., and the molten metal was cooled at a cooling speed of from 0.015° C./min. to 0.5° C/min and was annealed for about 2 hours at 300 to 500° C. to obtain the desired alloy. This was crushed to a powder of 50 micron or less average grain size, and the powder was subjected to dissolution treatment for 2 hours at 70° C. with a nitric acid aqueous solution. It was confirmed by analysis by using SEM-WDX that pores with a 2 micron mean diameter were formed, after sufficiently washing the powder with water.

The same result was obtained by reacting a chlorine gas stream or fluorine gas stream with the deposition phase of the powder to evaporate. The fluorine containing binder was added to this, it was applied on a copper foil, the coating and the copper foil were molded by a roller press, and the electrode of predetermined thickness was obtained.

The electrode whose principal component is LiCoO₂ was used as a positive electrode. A closed type lithium cell of the size AA battery type was manufactured by using these electrodes, and the discharge capacity was measured. The battery capacity was designed as 600 mAh.

Table 5 shows the result. The capacity of the 0.2 CmA discharge after a charge of 0.3 CmA was as high as 760 to 700 mAh, and the cycle life was as long as 530 to 480 times. The cell had 91 to 85% of the discharge capacity in the discharge of 3 CmA, and 98 to 88% of the discharge capacity at the charge of 3 CmA.

TABLE 5

| | After 0.3 CmA charge, | Cycle life | Discharge capacity at | Discharge capacity |
|---|---|---|---|---|
| Additives | discharge at 0. 2 CmA (mAh) | (Number) | 3 CmA discharge (%) | at 3 CmA charge (%) |
| Si-Ni | 760 | 510 | 91 | 98 |
| Ge-Si | 720 | 530 | 90 | 90 |
| Mg-Si | 700 | 480 | 85 | 91 |
| Si-Ni-Ge | 750 | 480 | 88 | 88 |
| Si-Ni-Mg | 700 | 500 | 91 | 90 |
| Si-Ni-Mn | 720 | 510 | 90 | 88 |
| Si-Ni-Cu | 750 | 480 | 88 | 95 |

### EXAMPLE 14

The oxides and sulfides shown in Table 6 were used as the positive electrode. The positive electrode materials shown in Table 6 were crushed to a powder of 1 micron or less average grain size. Then, 0.2 weight % of the additive powders having a 0.1 micron size shown in Table 6 were added to the above positive electrode material powders. The mixed powder was heat treated for 5 hours at 900 to 300° C. The heat treated powder was crushed to produce a powder of the desired grain size. This was subjected to dissolution treatment for 2 hours at 70° C. with a nitric acid aqueous solution. It was confirmed by using a SEM-WDX that the powder had pores of 0.2 micron mean diameter.

A chlorine gas stream or fluorine gas stream was reacted with the deposition phase to evaporate to obtain the same result. A fluorine containing binder was added to this, then it was applied to a copper foil. The coating and the copper foil were molded by a roller press to produce an electrode of predetermined thickness.

As a negative electrode, a carbon negative electrode was used. A closed type lithium cell of the size AA battery type was manufactured by using these electrodes, and the capacity was measured. The battery capacity was designed as 600 mAh.

Table 6 shows the result. The discharge capacity when 25 discharged at 0.2 CmA after a charge of 0.3 CmA was as high as 770 to 680 mAh, and the cycle life was as long as 640 to 490 times. The cell had 90 to 81% of the discharge capacity in the discharge at 3 CmA, and had 85 to 78% of the discharge capacity in the charge at 3 CmA.

TABLE 6

| Composition of | | After 0.3 CmA charge, 0.2 | Cycle life | 3 CmA | 3 CmA |
|---|---|---|---|---|---|
| Positive electrode | Aditives | CmA discharge (mAh) | (Number) | discharge (%) | charge (%) |
| LiCoO_{1, 6˜2, 5} | Al | 760 | 490 | 81 | 82 |
| LiMnO_{1, 6˜2, 5} | Sn | 770 | 510 | 88 | 85 |
| LiNiO_{1, 5˜2, 6} | Mn | 690 | 550 | 90 | 85 |
| LiFeO_{1, 5˜2, 5} | B | 700 | 540 | 87 | 84 |
| Li(Co Cr)_{1, 0}O_{1, 5˜2, 5} | K | 710 | 490 | 87 | 78 |
| Li(Co Pb)_{1, 0}O_{1, 5˜2, 5} | Na | 700 | 610 | 88 | 85 |
| Li(Co Bi)_{1, 0}O_{1, 5˜2, 5} | Al | 700 | 640 | 81 | 79 |
| Li(Ni Nb)_{1, 0}O_{1, 6˜2, 5} | Sn | 750 | 610 | 90 | 80 |
| Li(Ni Mo)_{1, 0}O_{1, 6˜2, 6} | Al | 680 | 500 | 87 | 79 |
| Li(Ni Sr)_{1, 0}O_{1, 5˜2, 5} | B | 710 | 490 | 86 | 80 |
| Li(Ni Ta)_{1, 0}O_{1, 5˜2, 6} | Sn | 770 | 550 | 88 | 79 |
| Li(Ni Fe)_{1, 0}O_{1, 5˜2, 5} | Al | 750 | 550 | 89 | 79 |
| Li(Ni Co)_{1, 0}O_{1, 5˜2, 5} | Al | 700 | 600 | 81 | 78 |
| Li(Co Mn)_{1, 0}O_{1, 5˜2, 5} | Sn | 710 | 610 | 85 | 85 |
| Li(Ni Mn)_{1, 0}O_{1, 6˜2, 5} | Al | 720 | 640 | 84 | 84 |
| Li(Ni Fe)_{1, 0}O_{1, 5˜2, 5} | Al | 740 | 610 | 81 | 81 |
| Li(Fe Co)_{1, 0}O_{1, 5˜2, 5} | B | 700 | 640 | 90 | 79 |
| Li(Fe Mn)_{1, 0}O_{1, 6˜2, 6} | Al | 680 | 610 | 89 | 85 |
| LiMn_{2, 0}O_{3, 0˜6, 0} | Sn | 680 | 600 | 90 | 83 |
| TiS_{1, 5˜2, 6} | Al | 690 | 590 | 90 | 84 |
| MoS_{1, 5˜2, 5} | B | 710 | 490 | 88 | 80 |
| (Mo Fe)_{1, 0}S_{1, 5˜2, 5} | Al | 690 | 500 | 87 | 80 |
| (Mo Ta)_{1, 0}S_{1, 5˜2, 5} | Sn | 680 | 490 | 81 | 80 |
| (Mo Sr)_{1, 0}S_{1, 5˜2, 6} | Al | 730 | 500 | 89 | 78 |
| (Mo Ni)_{1, 0}S_{1, 6˜2, 5} | B | 680 | 520 | 88 | 83 |
| (Mo Nb)_{1, 0}S_{1, 5˜2, 6} | Al | 710 | 510 | 87 | 82 |
| (Mo Pb)_{1, 0}S_{1, 5˜2, 5} | Sn | 700 | 550 | 89 | 85 |
| (Mo Cu)_{1, 0}S_{1, 6˜2, 6} | K | 680 | 510 | 90 | 80 |
| (Mo V)_{1, 0}S_{1, 5˜2, 6} | K | 710 | 580 | 88 | 82 |
| (Mo Mn)_{1, 0}S_{1, 6˜2, 5} | B | 750 | 620 | 87 | 79 |
| LiV₃O_{6, 0˜10, 0} | B | 770 | 560 | 87 | 84 |
| CuV₂O_{4, 6˜7, 5} | B | 750 | 560 | 82 | 80 |

### EXAMPLE 15

The hydrogen storage alloys including two kinds of phases shown in Table 7 were used as a negative electrode. Boron was added to the alloys of 1 wt %. The methods of manufacturing the alloys were a method of dissolution, a mechanical alloying method, a method of mechanical grinding, a molten metal quenching method, or a method of atomization. The obtained alloys were heat-treated at a temperature of 650 to 1100° C.

These alloys were subjected to dissolution treatment for 1 to 50 hours at 60 to 100° C. with a KOH aqueous solution, and the alloys were rinsed with water. The formation of pores was confirmed. As in example 1, the electrode was manufactured, a closed type nickel-metal hydride cell of the size M battery type was manufactured, and the capacity was measured.

Table 7 shows the result. The discharge capacity when discharged at 0.2 CmA after a charge of 0.3 CmA was as high as 1560 to 1400 mAh, and the cycle life was as long as 1020 to 880 times. The cell had 97 to 77% of the discharge capacity in the discharge at 3 CmA, and had 98 to 79% of discharge capacity of the charge at 3 CmA. It was confirmed that minute cracks were present when disassembling the cell, by observing the electrode with a SEM.

TABLE 7

| | | 0.3 CmA charge- | Cycle life | 3 CmA | 3 CmA |
|---|---|---|---|---|---|
| First phase | Second phase | 0.2 CmA discharge(mAh) | (Number) | discharge (%) | charge (%) |
| (La Ce Nd Pr)-(Ni Mn Al Co)_{4, 5˜5, 5} | Mg_{0 , 5˜5, 6}Ni | 1540 | 910 | 91 | 98 |
| (La Ce Nd Pr)-(Ni Mn Al Co B)_{4, 6˜5, 6} | La_{0, 5˜6, 5}B | 1520 | 920 | 82 | 90 |
| (La Ce Nd Pr)-(Ni Mn Al Co W)_{4, 5˜5, 6} | LaAl_{1, 5˜5, 6} | 1490 | 920 | 78 | 88 |
| (La Ce Nd Pr)-(Ni Mn Al Co Mo)_{4, 5˜5, 6} | Ti_{0, 6˜6, 5}Ni, La_{0, 5˜5, 5}Ni | 1480 | 910 | 85 | 90 |
| (La Ce Nd Pr)-(Ni Mn Al Co Mg)_{4, 5˜5, 6} | Ti_{0, 5˜5, 5}V, La_{0, 5˜5, 6}V | 1430 | 900 | 94 | 79 |
| (La Ce Nd Pr)-(Ni Mn Al Co K)_{4, 5˜5, 5} | Ti_{0, 5˜5, 5}Co, La_{0, 5˜5, 5} Co | 1510 | 950 | 88 | 88 |
| (La Ce Nd Pr)-(Ni Mn Al Co Na)_{4, 5˜5, 6} | Ti_{0, 5˜5, 5}Mn, La_{0, 5˜5, 5}Mn | 1500 | 950 | 89 | 89 |
| (La Ce Nd Pr)-(Ni Mn Al Co Pd)_{4, 5˜5, 6} | Ti_{0, 5˜5, 5}Cr, La_{0, 5˜5, 5}Cr | 1460 | 880 | 90 | 85 |
| (La Ce Nd Pr)-(Ni Mn Al Co Sn)_{4, 5˜5, 6} | Ti_{0, 5˜5, 5}Sn, La_{0, 5˜5, 5}Sn | 1400 | 890 | 95 | 88 |
| (La Ce Nd Pr)-(Ni Mn Al Co Fe)_{4, 5˜5, 5} | Ti_{0, 5˜5, 5}Fe, La_{0, 5˜5, 5 5}Fe | 1480 | 880 | 88 | 94 |
| (Ca La Ce Nd Pr)-(Ni Mn Al Co)_{4, 5˜6, 6} | Ti_{0, 6˜5, 5}V, La_{0, 5˜5, 6}V | 1500 | 890 | 86 | 92 |
| (Zr Ti)-(Ni Mn V Co B)_{1, 5˜2 5} | Ti_{0, 5˜6, 5}Ni | 1510 | 900 | 79 | 91 |
| (Zr Ti Hf)-(Ni Mn V Co Mo)_{1, 5˜2, 5} | Mg_{0, 5˜5, 5}Ni | 1560 | 910 | 89 | 90 |
| (Zr Ti Sc)-(Ni Mn V Co W)_{1, 5˜2, 5} | Ti_{0, 6˜6, 5}Ni, Nb_{0, 5˜5, 5}Ni | 1490 | 950 | 93 | 89 |
| (Zr Ti Mg)-(Ni Mn V Co K)_{1, 5˜2, 5} | Ti_{0, 5˜5, 5}V, Nb_{0, 5˜6, 6}V | 1450 | 950 | 84 | 98 |
| (Zr Ti)-(Ni Mn V Co Pd)_{1, 5˜2, 6} | Ti_{0, 5˜5, 5}Co, Hf_{0, 5˜5, 5}Co | 1400 | 910 | 79 | 89 |
| (Zr Ti)-(Ni Mn V Co Sn)_{1, 5˜2, 5} | Ti_{0, 6˜5, 5}Mn, Zr_{0, 5˜5, 5}Mn | 1410 | 950 | 81 | 97 |
| (Zr Ti)-(Ni Mn V Co Fe)_{1, 5˜2, 5} | Ti_{0, 5˜5, 5}V, Y_{1, 5˜6, 5}V | 1480 | 890 | 84 | 91 |
| (Zr Ti)-(Ni Mn V Co Cr)_{1, 5˜2, 5} | Ti_{0, 5˜5, 5}Cr, La_{0, 5˜5, 5}Cr | 1500 | 890 | 94 | 87 |
| (Zr Ti)-(Ni Mn V Co Li)_{1, 5˜2, 6} | Ti_{0, 6˜6, 5}Sn, La_{0, 5˜6, 5}Sn | 1470 | 880 | 83 | 80 |
| (Zr Ti)-(Ni Mn V Co Fe)_{1, 5˜2, 5} | Ti_{0, 6˜5, 5}Fe | 1510 | 890 | 77 | 89 |
| (Zr Ti)-(Ni Mn V Co Cr)_{1, 5˜2, 5} | Ti_{0, 5˜5, 5}Ni | 1410 | 880 | 90 | 86 |
| (Zr Ti)-(Ni Mn V Co Al)_{1, 5˜2, 5} | Nb_{0, 5˜5, 6}Ni | 1480 | 900 | 93 | 97 |
| (Zr Ti)-(Ni Mn V Co Cr Fe)_{1, 5˜2, 5} | La_{0, 5˜5, 5}Fe | 1460 | 940 | 90 | 79 |
| (Zr Ti)-(Ni Mn V Co C)_{1, 5˜2, 5} | Ti_{0, 5˜5, 5}Ni, Nb_{0, 5˜6, 6}Ni | 1450 | 1010 | 95 | 88 |
| (Zr Ti)-(Ni Mn V Co Pb)_{1, 5˜2, 5} | Ti_{0, 5˜5, 6}V, Nb_{0, 5˜6, 5}V | 1530 | 890 | 91 | 97 |
| (Zr Ti)-(Ni Mn V Co Sn)_{1, 5˜2 6} | Ti_{0, 5˜5 6}Mn, Zr_{1, 5˜5, 6}Mn | 1500 | 930 | 89 | 99 |
| (Mg Zr Ti)_{2 0}-(Ni Mn V Co B)_{0 6˜1 5} | Ti_{0, 5˜6, 5}Co, Hf_{0, 5˜5, 6}Co | 1540 | 980 | 78 | 89 |
| (Mg Zr Ti)_{2, 0}-(Ni Mn V Co W)_{0, 5˜1, 6} | Ti_{0, 5˜6, 5}Cr, La_{0, 5˜5, 6}Cr | 1540 | 980 | 90 | 79 |
| (Mg Zr Ti)_{2, 0}-(Ni Mn V Co Mo)_{0, 6˜1, 5} | Ti_{0, 5˜5, 6}V, Y_{0, 5˜5, 6}V | 1510 | 1020 | 82 | 82 |
| (Mg Zr Ti)_{2, 0}-(Ni Mn V Co)_{0, 5˜1, 5} | Ti_{0, 5˜5, 5}Ni, Nb_{0, 5˜6, 6}Ni | 1500 | 940 | 91 | 97 |
| (Mg Zr Ti)_{2 0}-(Ni Mn Al Co)_{0, 6˜1 6} | Mg_{0, 6˜5, 6}Ni | 1440 | 930 | 98 | 98 |
| (Mg Zr Ti)_{2 0}-(Ni Mn Al Co B)_{0, 6˜1 6} | Mg_{0, 5˜5, 6}Ni | 1410 | 900 | 97 | 92 |
| (Mg Zr Ti)_{2 0}-(Ni Mn Al Co W)_{0, 6˜1, 6} | Mg_{0, 6˜6, 5}Ni | 1460 | 910 | 89 | 94 |
| (Mg Zr Ti)_{2 0}-(Ni Mn V Co Mo)_{0, 6˜1, 6} | Mg_{0, 6˜6, 5}Ni | 1400 | 990 | 90 | 91 |

### EXAMPLE 16

The carbon materials including two kinds of phases shown in table 8 were used as a negative electrode. 1 weight % of boron was added to these materials, and the materials were heat-treated at a temperature of 550 to 2600° C. The materials were subjected to dissolution treatment for 1 to 50 hours at 50 to 100° C. with a mixed solution formed of a KOH aqueous solution and a sodium hydroborate aqueous solution. The materials were processed for 1 to 50 hours at 30 to 60° C. with a mixed solution of propylene carbonate and dimethoxyethane. The formation of the desired pores was confirmed. Like example 3, the electrode was manufactured, a closed type lithium cell of the size AA battery type was manufactured, and the capacity was measured.

Table 8 shows the result. The capacity when discharged at 0.2 CmA after a charge at 0.3 CmA was as high as 830 to 610 mAh, and the cycle life was as long as 980 to 780 times. The cell had 93 to 83% discharge capacity of the discharge at 3 CmA and had 95 to 86% discharge capacity of the charge at 3 CmA.

It was confirmed that minute cracks were formed when disassembling the cell, observing the electrode with a SEM.

TABLE 8

| | | 0.3 CmA charge | Cycle life | 3 CmA discharge | 3 CmA charge |
|---|---|---|---|---|---|
| First phase | Second phase | 0.2 CmA discharge (mAh) | (Number) | (%) | (%) |
| graphite | Ag | 800 | 930 | 91 | 88 |
| graphite | Sn | 660 | 820 | 88 | 89 |
| graphite | Pd | 760 | 870 | 93 | 95 |
| graphite | Ga | 690 | 880 | 88 | 89 |
| graphite | In | 780 | 860 | 89 | 91 |
| graphite | Ag-In | 770 | 900 | 84 | 92 |
| graphite | Sn-Ga | 830 | 940 | 87 | 94 |
| graphite | polyaniline | 810 | 920 | 86 | 91 |
| graphite | Ag-Cu | 790 | 850 | 83 | 89 |
| amorphous C | Ag | 670 | 840 | 90 | 94 |
| amorphous C | La | 690 | 790 | 89 | 95 |
| amorphous C | Pd | 800 | 920 | 91 | 89 |
| amorphous C | polyacene | 650 | 980 | 91 | 87 |
| amorphous C | polyparaphenylene | 640 | 820 | 93 | 89 |
| amorphous C | In | 610 | 780 | 90 | 86 |

### EXAMPLE 17

The oxides including two kinds of phases shown in Table 9 were used as a positive electrode. 1 weight % of boron was added to these materials, and the materials were subjected to heat treatment at 250 to 600° C. The materials were processed for dissolution treatment for 1 to 50 hours at 50 to 100° C. with an acetic acid aqueous solution. The formation of the desired pores was confirmed. As in example 3, the electrode was manufactured, a closed type lithium cell of the size M battery type was manufactured, and the capacity was measured.

Table 9 shows the result. The discharge capacity when discharged at 0.2 CmA after a charge at 0.3 CmA was as high as 810-680 mAh, and the cycle life was 820 to 580 times. The cell had 95 to 80% of the discharge capacity of the discharge at 3 CmA, and had 98 to 82% of the discharge capacity of the charge at 3 CmA. It was confirmed that minute cracks were formed when disassembling the cell, by observing the electrode with a SEM.

TABLE 9

| | | 0.3 CmA charge - 0.2 CmA | Cycle life | 3 CmA | 3 CmA |
|---|---|---|---|---|---|
| First phase | Second phase | discharge (mAh) | (Number) | discharge (%) | charge (%) |
| Li0.5 - 1.5 Fe01.5 - 2.5 | Li0.5 - 1.5 Co01.5 - 2.5 | 800 mAh | 630 | 91 | 88 |
| Li0.5 - 1.5 Co01.5 - 2.5 | Li0.5 - 1.5 Mn01.5 - 2.5 | 810 | 620 | 88 | 98 |
| Li0.5 - 1.5 Co01.5 - 2.5 | Li0.5 - 1.5 Vo01.5 - 2.5 | 690 | 770 | 93 | 95 |
| Li0.5 - 1.5 Mn01.5 - 2.5 | Li0.5 - 1.5 Co01.5 - 2.5 | 790 | 680 | 80 | 89 |
| Li0.5 - 1.5 Mn01.5 - 2.5 | Li0.5 - 1.5 Sn01.5 - 2.5 | 780 | 660 | 89 | 91 |
| Li0.5 - 1.5 Ni01.5 - 2.5 | Li0.5 - 1.5 Co01.5 - 2.5 | 770 | 700 | 84 | 92 |
| Li0.5 - 1.5 Ni01.5 - 2.5 | Li0.5 - 1.5 Mn01.5 - 2.5 | 730 | 640 | 87 | 94 |
| Li0.5 - 1.5 Fe01.5 - 2.5 | Li0.5 - 1.5 V01.5 - 2.5 | 690 | 650 | 83 | 89 |
| Li0.5 - 1.5 V01.5 - 2.5 | Li0.5 - 1.5 Co01.5 - 2.5 | 720 | 590 | 95 | 98 |
| Li0.5 - 1.5 V01.5 - 2.5 | Li0.5 - 1.5 Mn01.5 - 2.5 | 710 | 580 | 89 | 92 |
| Li0.5 - 1.5 Cu01.5 - 2.5 | Li0.5 - 1.5 Co01.5 - 2.5 | 680 | 720 | 84 | 82 |
| Li0.5 - 1.5 Co01.5 - 2.5 | Li0.5 - 1.5 Mn01.5 - 2.5 | 810 | 820 | 81 | 86 |

### EXAMPLE 183

A hydrogen storage alloy having a composition of Nb_{0.1}Zr_{0.9}N_{1.1}Mn_{0.6}V_{0.2}Co_{0.1}B_{0.03} was used as a negative electrode. The method of manufacturing the alloy is the following. The alloy powder was sprayed by a method of atomization in an Ar gas atmosphere (method of gas atomizing) into which oxygen of 10 to 1000 ppm was mixed, and then the alloy powder was subjected to heat treatment at 650 to 1100° C. When observing this section with a SEM, several pores were confirmed. The formation of the coating consisting of oxygen and Zr when analyzing the composition of the pores was confirmed.

Like example 1, the electrode was manufactured, a closed type nickel-metal hydride cell of the size AA battery type was manufactured, and the capacity was measured. The discharge capacity when discharged at 0.2 CmA after a charge at 0.3 CmA was as high as 1540 mAh, and the cycle life was as long as 1080 times. The cell had 97% of the discharge capacity of the discharge at 3 CmA, and had 89% of the discharge capacity of the charge at 3 CmA. It was confirmed that minute cracks were formed when disassembling the cell by observing the electrode with a SEM.

### EXAMPLE 19

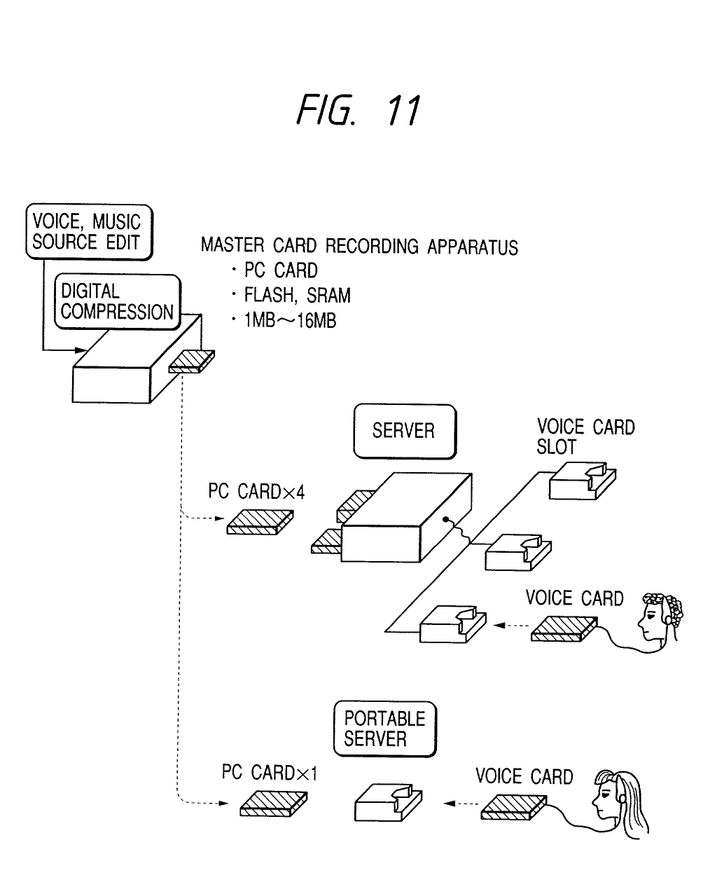

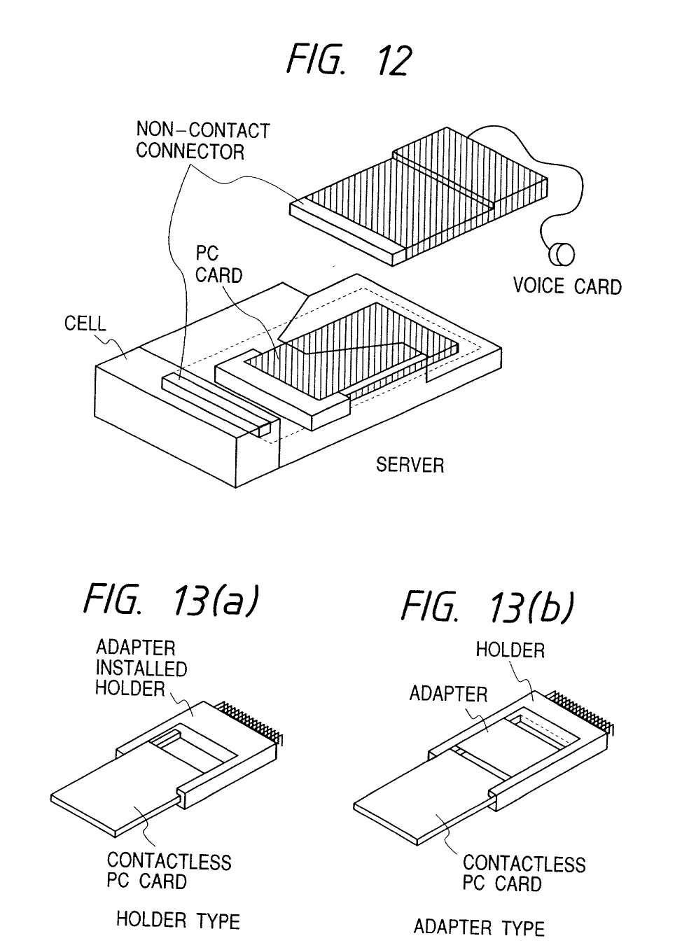

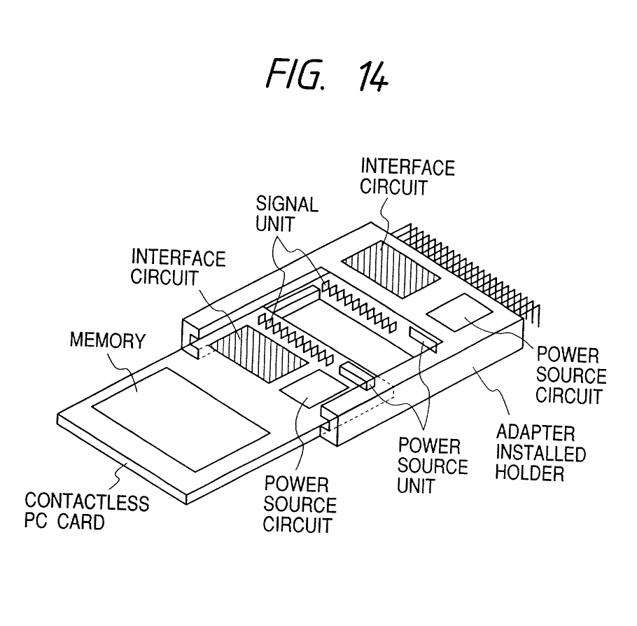

An example of applying the combined cells of examples 1-18 to a voice card system is considered. FIG. 11 shows an example of the guidance system using the voice card. FIG. 12 shows an example of the construction of the server and the card. FIGS. 13(a) and 13(b) and FIG. 14 show an example of the PC card. The voice card system was composed of a voice card having a semiconductor memory and audio regeneration function and a server storing the compressed digital audio data.

The secondary batteries of examples 1-18 were installed in the server. The capacity of these secondary batteries was 2-10 Wh. And, the charging time was 30 minutes. The longest operation time of the server at this time was 5 to 50 hours. The ratio of the longest operation time against the charging time was 10-100. And, the secondary batteries of examples 1-18 were installed in the PC card. The capacity of the secondary battery was 0.5 Wh. The charging time was 30 minutes.

The longest operation time of the PC card at this time was 50 to 100 hours. The ratio of the longest operation time to the charging time was 100-200.

### COMPARATIVE EXAMPLE 13

Like example 19, the secondary battery of comparative examples 1-12 was installed in the server. The capacity of the secondary battery was 2-10 Wh. The charging time was 1 hour.

The longest operation time of the server at this time was as short as 0 to 8 hours. Most of the cells exhibited a liquid leak and did not make a normal discharge. The secondary batteries of comparative examples 1-12 also were installed in the PC card. The capacity of the secondary battery was 0.5 Wh. The charging time was 1 hour.

The longest operation time of the PC card at this time was the O to 9.5 h, and the ratio of the longest operation time to the charging time was O to 9.5. Most of the cells exhibited a liquid leak and did not make a normal discharge.

### EXAMPLE 20

A TFT circuit substrate in which a five inch liquid crystal display panel, a high-speed bus interface, a drawing controlling circuit, a display interface, a synchronous control, a field memory storage controller, a circumference circuit for the panel driving and a field memory storage were integrated was manufactured.

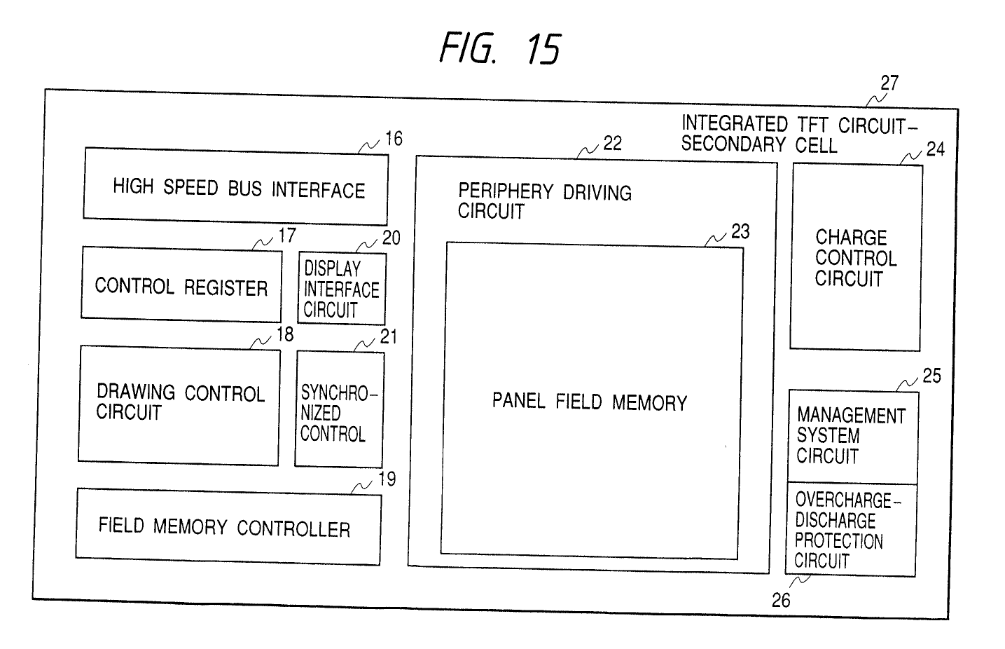

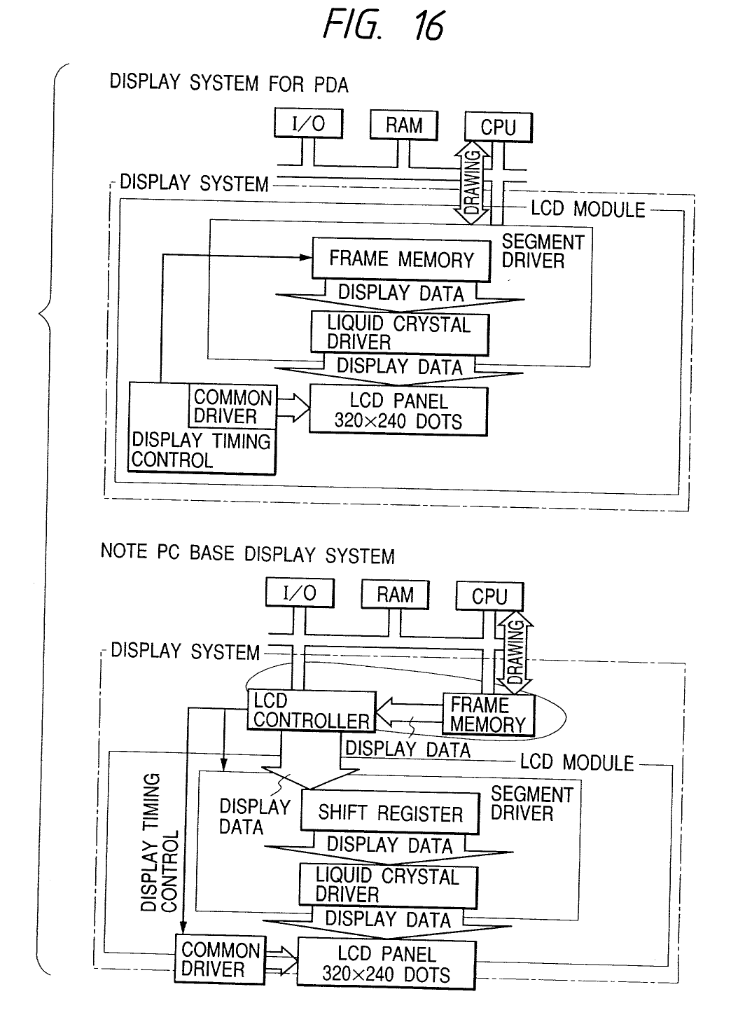

The secondary batteries of examples 1-18 were mounted on the rear side of the substrate. A display of the reflection mode type was used for the liquid crystal display panel. The diagram of the TFT circuit substrate is shown in FIG. 15. A liquid crystal display system was manufactured by using this. The capacity of the secondary battery was 30-85 Wh. The charge time was 30 minutes at 60 to 170 W.

The longest operation time of the display at this time was 40 to 100 hours. The ratio of the longest operation time to the charging time was 80-200.

### COMPARATIVE EXAMPLE 14

As in example 20, the secondary battery of comparative examples 1-12 was mounted on the rear side of the substrate. A liquid crystal display system was manufactured using this. The capacity of the secondary battery was 30 85 Wh. The charging time was 30 minutes at 60 to 170 W.

The longest operation time of the display at this time was as short as O to 4 hours, and the ratio of the longest operation time to the charging time was O to 8. Most of the cells exhibited a liquid leak, and the normal discharge of the cells could not be obtained.

### EXAMPLE 21

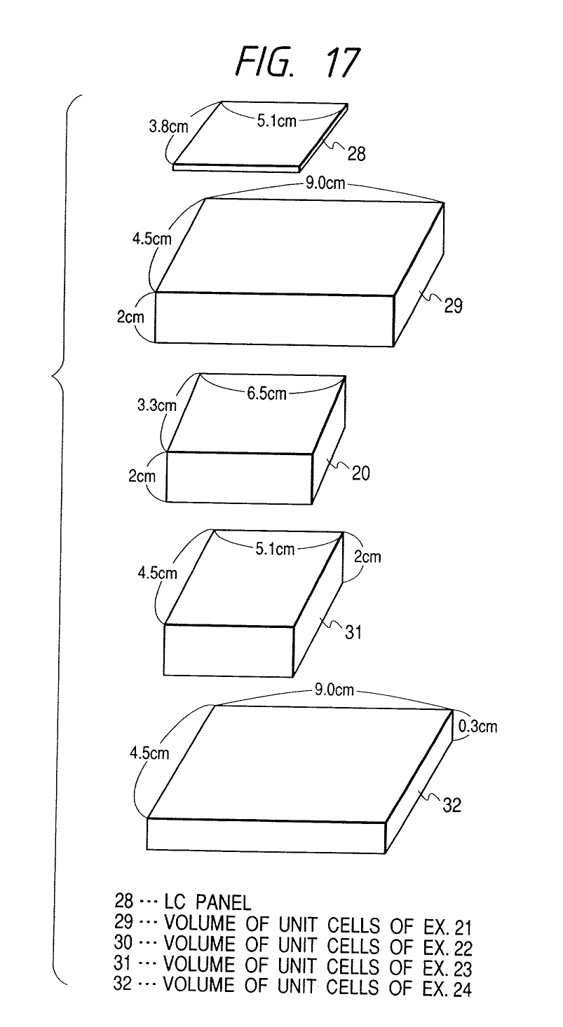

An example of a 2.5 inch liquid crystal display system is shown in FIG. 16. The secondary battery was arranged in the rear side of this liquid crystal display panel. FIG. 17 shows the volume of the set of the secondary batteries of example 1. The secondary batteries were put in a space having a width of 4.5 cm, a length of 9 cm and a thickness of 2 cm. The capacity of the secondary batteries was 20 Wh. The charging time was 30 minutes at 40 W.

The longest operation time of the display at this time was 20 hours. The ratio of the longest operation time to the charging time was 40.

### EXAMPLE 22

An example of the 2.5 inch liquid crystal display system is shown in FIG. 16. The secondary batteries were arranged in the rear side of this liquid crystal display panel. The volume of the set of the secondary batteries of example 10 is shown in FIG. 17. The secondary battery was put in a space having a width of 3.3 cm, a length of 6.5 cm and a thickness of 2 cm. The capacity of the secondary batteries was 15 Wh. The charging time was 30 minutes at 30 W.

The longest operation time of the display at this time was 10 hours. The ratio of the longest operation time to the charging time was 20.

### EXAMPLE 23

The example of the 2.5 inch liquid crystal display system is shown in FIG. 16. The secondary batteries were arranged in the rear side of this liquid crystal display panel. The volume of the set of the secondary batteries of example 10 is shown in FIG. 17. The secondary battery was put in a space having a width of 4.5 cm, a length of 5.1 cm and a thickness of 2 cm. The capacity of the secondary batteries was 15 Wh. The charge time was 30 minutes at 30 W.

The longest operation time of the display at this time was 10 hours. The ratio of the longest operation time to the charging time was 20.

### EXAMPLE 24

The example of the 2.5 inch liquid crystal display system is shown in FIG. 16. The secondary battery was arranged in the rear side of this liquid crystal display panel. The volume of the set of the secondary batteries of example 10 is shown in FIG. 17. The secondary battery was put in a space having a width 4.5 cm, a length of 9 cm and a thickness of 0.3 cm. The capacity of the secondary batteries was 5 Wh. The charging time was 30 minutes at 10 W.

The longest operation time of the display at this time was 10 hours. The ratio of the longest operation time to the charging time was 20.

### EXAMPLE 25

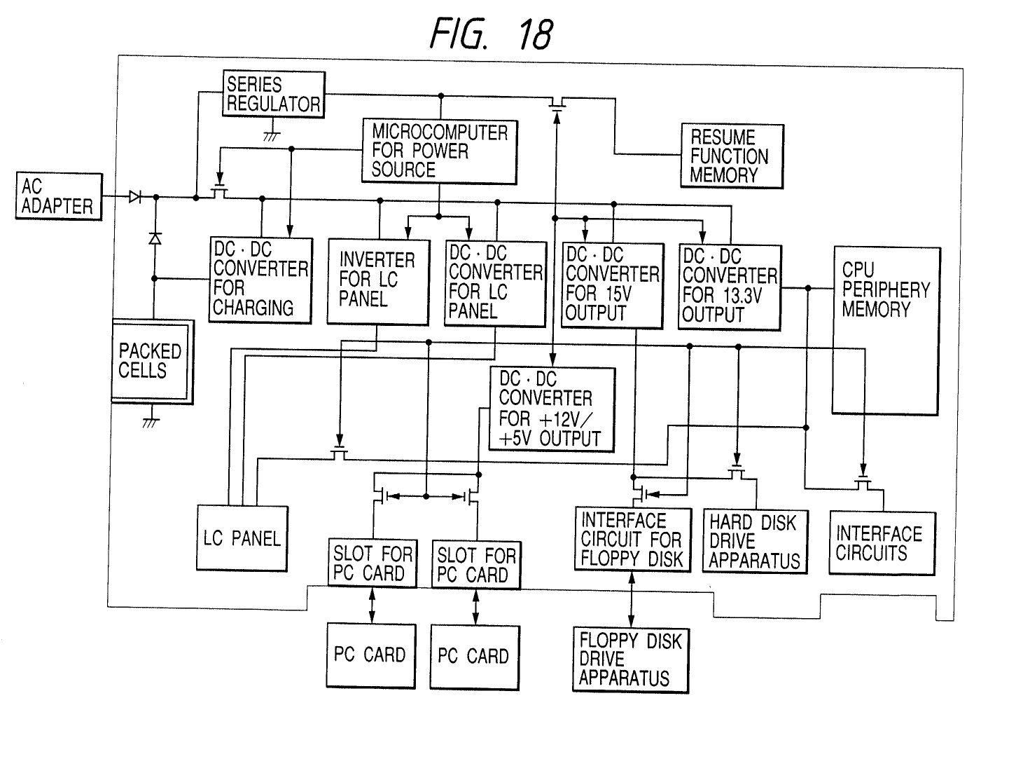

An example of the power management function of the note-type personal computer is shown in FIG. 18. As a secondary battery, operation confirmation was done by using the secondary battery of the cell of examples 1-18. The cell showed the longest operation time of 10 to 50 hours with respect to a 30 minute charge. The cell was applied to a portable telephone and also to a PHS. The receiving stand-by-time that is the longest operation time was 10 to 15 hours.

### EXAMPLE 26

The secondary batteries of examples 1-18 were applied to an electric vehicle. The body weight was 1000 kg, and the weight of the mounted secondary batteries was 200 kg. The charging time was 30 minutes. At this time, the running distance at a driving speed of 40 km/h was 250-550 km.

The minimum time necessary for the movement from standstill to 400 m was 10 to 18 seconds.

### EXAMPLE 27

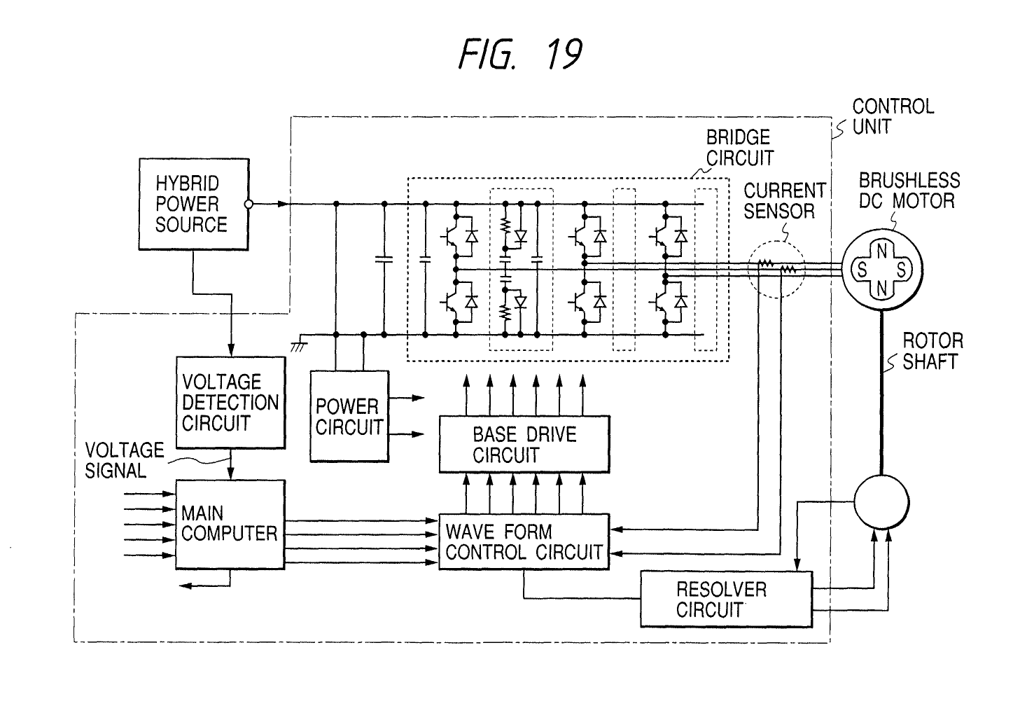

The secondary batteries of examples 1-18 were applied to a hybrid electric power unit used for the driving of an electric vehicle. The driving control system of the electric vehicle using one example of the hybrid electric power unit is shown in FIG. 19. The hybrid power source is connected with the control part through an output terminal. The electric power supplied from the hybrid power source is converted into a three-phase alternating current through a bridge circuit.

The rotation axis of a brush-less DC motor is connected to the driving mechanism of the electric vehicle and is connected to a rotor position transducer.

A resolver circuit inputs a resolver signal and outputs a signal that represents an excitation phase to the electric current ripple controlling circuit. The signal from the voltage detector is input into the main computer as well as the signal, etc. from the velocity sensor. These signals are supplied to the electric current ripple controlling circuit. The electric current ripple controlling circuit outputs pulse width modulation signals to the base drive circuit.

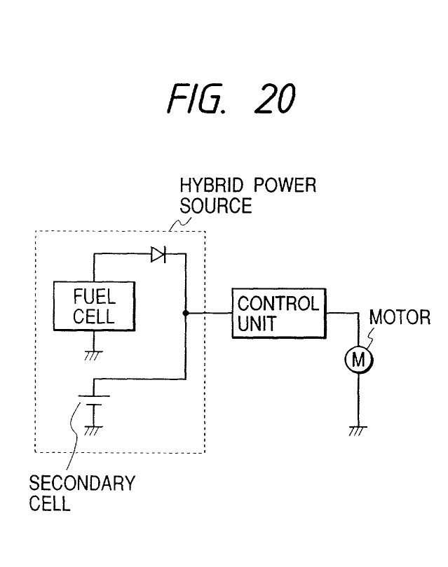

The base drive circuit drives the bridge circuit in response to the pulse width modulation signal. An example of the hybrid power source is shown in FIG. 20. The secondary batteries of examples 1-18 were used as a secondary battery electric power resource that supplies electric power to the control unit. As a fuel cell, cells such as the phosphoric acid type, the methanol type, the molten carbonate type or the macromolecule solid electrolyte type can be used.

The fuel cell is connected to the secondary battery in parallel through the diode for contraflow prevention. According to the travel motion condition of the electric vehicle, the electric power can be supplied selectively from the fuel cell or the secondary battery to the control unit.

The body weight was 1000 kg, the weight of the mounted secondary batteries was 100 kg, and the weight of the fuel cell was 100 kg. The charging time was 30 minutes. The running distance at a driving speed of 40 km/h was 300-550 km.

A large energy capacity of the secondary cell system was achieved by the present invention, and the rapid charging property and the rapid discharge property were greatly improved.

What is claimed is:

1. A system using a secondary cell comprising at least one of a heat source, motor, controlling circuit, driving circuit, LSI, IC and display element, each having a capacity of 0.5 to 50 kWh, and secondary cells, wherein at least one of the secondary cells includes a positive electrode and a negative electrode and has a discharge time of at least 15 minutes at a discharge of 580 W/l or more, and at least one of the positive electrode and the negative electrode containing a particle with cracks.

2. A system using a secondary cell comprising at least one of a heat source, motor, controlling circuit, driving circuit, LSI, IC and display element, each having a capacity of 0.5 to 50 kWh, and secondary cells, wherein at least one of the secondary cells includes a positive electrode and a negative electrode and has the ability to provide a discharge of 200 Wh/l or more at a charge of 300 W/l or more and at a discharge capacity of 90% or more, and at least one of the positive electrode and the negative electrode containing a particle with cracks.

3. A system using a secondary cell comprising at least one of a heat source, motor, controlling circuit, driving circuit, LSI, IC and display element, each having a capacity of 0.5 to 50 kWh, and secondary cells, at least one of the secondary cells including a positive electrode and a negative electrode, and at least one of the positive electrode and the negative electrode containing a particle with cracks, wherein the ratio of the longest operation time of the system against the charge time is 10 or more, preferably 40 to 200.

4. The system using a secondary cell according to any one of claims 1 to 3, further comprising at least one of a liquid crystal display, multiple-layered wiring board, PCMCIA card (PC card), voice card, modem, portable telephone, FAX and IC for battery.

5. A system using a secondary cell in a liquid crystal display device, comprising a liquid crystal display panel, a circumference circuit for driving the panel, a display interface circuit and a memory storage, wherein the secondary cells are able to make a rapid charge of one hour or less, preferably 30 minutes or less, and to perform a continuous operation of 10 hours or more, preferably 40 hours or more, and at least one of the secondary cells including a positive electrode and a negative electrode, at least one of the positive electrode and the negative electrode containing a particle with cracks.

6. In a liquid crystal display system which uses a system using the secondary cell of claim 5, wherein the secondary cells have a capacity of 2 Wh or more per 1 inch of the length liquid crystal display panel, which further comprises at least one of a battery charger, charge control equipment, charge controlling circuit and management system.

7. In the liquid crystal display system according to claim 6, wherein the liquid crystal display system has a space of a length of 0.85 to 1.2 to the width of the screen of the liquid crystal display panel, a length of 1.0 to 1.8 to the length of the screen of the liquid crystal display panel and a thickness of 3 to 20 mm, and the secondary batteries are provided in this volume.

8. In the liquid crystal display system according to claim 6, wherein the liquid crystal display system is provided with secondary batteries composed of a set of six cells in parallel or less and two in series or less.

9. A liquid crystal display system comprising secondary batteries which are lithium secondary batteries, at least one of the lithium secondary batteries including a positive electrode and a negative electrode, wherein at least one of the positive and negative electrode contains a particle with cracks.

10. In the liquid crystal display system according to claim 6, wherein the liquid crystal display system is provided with 3 to 5 secondary batteries in series and 4 in parallel or less.

11. The liquid crystal display system of which the secondary batteries of the liquid crystal display system of claim 10 are nickel-hydrogen secondary batteries.

12. The system using secondary cells of claim 4, wherein at least one of a liquid crystal display, multiple-layered wiring board, PCMCIA card (PC card), voice card, modem and IC for battery is integrated with the secondary batteries.

13. The system using secondary cells of claim 12, which comprises an overcharge prevention circuit of the secondary battery, over discharge prevention circuit or charging and discharging controlling circuit, which are integrated with the circuit in the system.

14. The system having the function of a portable information terminal, a portable computer, a pencomputer, a portable telephone, a personal-handy phone and a video telephone using the liquid crystal display system of any one of claims 5 to 11.

15. In the system using secondary cells of any one of claims 1-3 and 5, which further comprises at least one of an electric vehicle, an elevator, an electric car a hybrid power source including a combination of an engine and at least one of batteries and cells, a car driven by said hybrid power source, and an emergency power source.

16. In an electric vehicle using secondary cells with a motor driven by at least one secondary battery as a power source, wherein the at least one secondary battery is capable of being charged within 30 minutes or less, and being able to run for the travel of 250 km or more at a driving speed of 40 km/in or more, and at least one of the secondary cells including a positive electrode and a negative electrode, at least one of the positive electrode and the negative electrode containing a particle with cracks.

17. In the electric vehicle of claim 16, wherein the minimum time for the movement from a stopping point of the electric vehicle to 400 m is 18 seconds or less.

18. In an electric vehicle using a secondary battery with a control unit for controlling the output thereof, which comprises at least a motor driven by the secondary battery and a fuel cell or a solar battery as a power source, the secondary battery being capable of being charged within 30 minutes or less, the running distance that the travel motion at the driving speed of 40 km/in being 300 km or more in one discharge of the secondary battery and one generation of electrical energy of the fuel cell or the solar battery, and the sum of the weight of the secondary battery and the fuel cell or the solar battery is 250 kg or less, the secondary battery including at least one positive electrode and negative electrode, and at least one of the positive electrode and the negative electrode containing a particle with cracks.

19. A system according to any one of claims 1-3 and 5, further comprising an electrolyte which separates said positive electrode and negative electrode.

20. A system according to any one of claims 1-3 and 5, wherein said particle comprises at least two phases including different elements and said particle with cracks is generated in at least one phase of said at least two phases.

21. A system according to claim 20, wherein said particle contains fine pores.

22. A system according to any one of claims 1-3 and 5, wherein said particle contains fine pores.

23. A liquid crystal display system according to claim 9, further comprising an electrolyte which separates said positive electrode and said negative electrode.

24. A liquid crystal display system according to claim 9, wherein said particle comprises at least two phases including different elements and said particle with cracks is generated in at least one phase of said at least two phases.

25. A liquid crystal display system according to claim 24, wherein said particle contains fine pores.

26. A liquid crystal display system according to claim 9, wherein said particle contains fine pores.

27. In an electric vehicle according to any one of claims 16 and 18, further comprising an electrolyte which separates said positive electrode and said negative electrode.

28. In an electric vehicle according to any one of claims 16 and 18, wherein said particle comprises at least two phases including different elements, and said particle with cracks is generated in at least one phase of said at least two phases.

29. In an electric vehicle according to claim 28, wherein said particle contains fine pores.

30. In an electric vehicle according to any one of claims 16 and 18, wherein said particle contains fine pores.
